(19) United States
(12) Patent Application Publication
(10) Pub. No.: US 2026/0025895 A1
(43) Pub. Date: Jan. 22, 2026

(54) CONFIGURATION OF A LOAD CONTROL DEVICE FOR A LIGHT-EMITTING DIODE LIGHT SOURCE

(71) Applicant: Lutron Technology Company LLC, Coopersburg, PA (US)

(72) Inventors: Minh Tri Chau, Bethlehem, PA (US); Venkatesh Chitta, Center Valley, PA (US); Mark Eiding, Quakertown, PA (US); Mark Ryan Lopez, Lansdale, PA (US); Harsh Hitesh Mehta, Bethlehem, PA (US); John F. Yamrick, Souderton, PA (US)

(73) Assignee: Lutron Technology Company LLC, Coopersburg, PA (US)

(21) Appl. No.: 19/274,206

(22) Filed: Jul. 18, 2025

Related U.S. Application Data
(60) Provisional application No. 63/673,481, filed on Jul. 19, 2024.

(51) Int. Cl. H05B 47/19; H05B 45/10; H05B 45/20

(52) U.S. Cl. CPC H05B 47/19; H05B 45/10; H05B 45/20

(57) ABSTRACT

A load control device may be provided that is configured to control a light source having a plurality of emitter circuits. The load control device may include a plurality of drive circuits for controlling respective ones of the emitter circuits, a memory configured to store data, a communication circuit configured to receive messages, and a control circuit. The control circuit may be configured to control each of the drive circuits to control an individual intensity level of the respective emitter circuit. The control circuit may be configured to receive a message including configuration data having a light source type, store the configuration data having the light source type, and control the drive circuits to adjust the individual intensity level of each of the emitter circuits to adjust a present color of the cumulative light emitted by the emitter circuits towards a target color based on the light source type.

### CROSS-REFERENCE TO RELATED APPLICATIONS

This application claims priority from Provisional U.S. Patent Application No. 63/673,481, filed Jul. 19, 2024, the entire disclosure of which is hereby incorporated by reference herein in its entirety.

### BACKGROUND

During the installation of typical load control systems, standard mechanical switches, such as traditional toggle switches or decorator paddle switches, may be replaced by more advanced load control devices, such as dimmer switches, that control the amount of power delivered from an alternating current (AC) power source to one or more electrical loads. Such an installation procedure typically requires that the existing mechanical switch be disconnected from the electrical wiring and removed from a wallbox in which it is mounted, and that the load control device then be connected to the electrical wiring and installed in the wallbox. An average consumer may not feel comfortable performing the electrical wiring required in such an installation. Accordingly, such a procedure may typically be performed by an electrical contractor or other skilled installer. However, hiring an electrical contractor may be cost prohibitive to the average consumer.

Controllable light sources, such as controllable screw-in light-emitting diode (LED) lamps, may provide an easier solution for providing advanced control of lighting. For example, an older incandescent lamp may simply be unscrewed from a socket and the controllable light source may be screwed into the socket. The controllable light sources may be controlled by remote control devices. However, the sockets in which the controllable light sources are installed may be controlled by an existing wall-mounted light switch. When the wall-mounted light switch is operated to an off position, power to the controllable light source may be cut, such that the controllable light source may no longer respond to commands transmitted by the remote control devices. Accordingly, it is desirable to prevent operation of such a wall-mounted light switch to ensure that the delivery of power to the controllable light source continues uninterrupted.

### SUMMARY

Method, systems, and at least one computer-readable storage mediums may be configured to perform any combination of the following. For example, a load control device may be provided that is configured to control a light source having a plurality of emitter circuits. The load control device may include a plurality of drive circuits for controlling respective ones of the emitter circuits, a memory configured to store data, a communication circuit configured to receive messages, and a control circuit. The control circuit may be configured to control each of the drive circuits to control an individual intensity level of the respective emitter circuit. The control circuit may be configured to receive, via the communication circuit, a message including configuration data having a light source type. The control circuit may be configured to store, in the memory, the configuration data having the light source type. The control circuit may be configured to control the drive circuits to adjust the individual intensity level of each of the emitter circuits to adjust a present color of the cumulative light emitted by the emitter circuits towards a target color based on the light source type in the configuration data stored in the memory.

The control circuit may be configured to adjust a present color temperature of the cumulative light emitted by the emitter circuits towards a target color temperature when operating in a color-temperature-control mode, and adjust a present color value of the cumulative light emitted by the emitter circuits towards a target color value when operating in a full-color-control mode. In some examples, such as in response to the light source type in the configuration data stored in the memory, the control circuit may be configured to determine which of the plurality of drive circuits to control. For instance, the control circuit may be configured to determine a number of emitter circuits in the light source in response to the light source type in the configuration data stored in the memory, and determine which of the plurality of drive circuits to control in response to the number of emitter circuits indicated by the light source type.

The control circuit may be configured to determine an emitter color of each of the emitter circuits in the light source in response to the light source type in the configuration data stored in the memory, and determine which of the plurality of drive circuits to control in response to the emitter color of each of the emitter circuits indicated by the light source type. In some examples, the emitter color may indicate a respective color temperature of emitters of one of the emitter circuits when the emitter circuit includes broad-spectrum light-emitting diodes, and/or indicate a color value of emitters of one of the emitter circuits when the emitter circuit includes non-broad-spectrum light-emitting diodes. For example, when the light source type indicates that the light source comprises two emitter circuits having broad-spectrum light-emitting diodes and three emitter circuits having non-broad-spectrum light-emitting diodes and a last-received color-adjustment commands was a color-temperature-adjustment command, the control circuit may be configured to determine to operate in the color-temperature-control mode. When the target color temperature is between a first color temperature and a second color temperature of respective ones of the two emitter circuits having broad-spectrum light-emitting diodes, the control circuit may be configured to determine to control two of the plurality of drive circuits for controlling the two emitter circuits having broad-spectrum light-emitting diodes and one of the plurality of drive circuits for controlling one of the emitter circuits having non-broad-spectrum light-emitting diodes.

When the target color temperature is not between the first color temperature and the second color temperature, the control circuit may be configured to determine to control one of the plurality of drive circuits for controlling the one of the emitter circuits having broad-spectrum light-emitting diodes and two of the plurality of drive circuits for controlling two of the emitter circuits having non-broad-spectrum light-emitting diodes. In some examples, a color value of the one of the emitter circuits having non-broad-spectrum light-emitting diodes that is controlled by the one of the plurality of drive circuits is green.

In some examples, when the light source type indicates that the light source comprises two emitter circuits having broad-spectrum light-emitting diodes and three emitter circuits having non-broad-spectrum light-emitting diodes and a last-received color-adjustment command was a full-color-adjustment command, the control circuit may be configured to determine to operate in the full-color-control mode and to control three of the plurality of drive circuits for controlling the three emitter circuits having non-broad-spectrum light-emitting diodes. When the light source type indicates that the light source comprises three emitter circuits and each of the emitter circuits comprise non-broad-spectrum light-emitting diodes, the control circuit may be configured to determine to operate in the full-color-control mode and to control three of the plurality of drive circuits. When the light source type indicates that the light source comprises three or more emitter circuits and each of the emitter circuits comprise broad-spectrum light-emitting diodes, the control circuit may be configured to determine to operate in the color-temperature-control mode and to control two of the plurality of drive circuits based on the target color temperature and the emitter color of each of the emitter circuits indicated by the light source type.

When the light source type indicates that the light source comprises two emitter circuits, the control circuit may be configured to operate in the color-temperature-control mode and to determine to control two of the plurality of drive circuits. In some examples, in response to the light source type in the configuration data stored in the memory, the control circuit may be configured to determine duty cycles for generating drive signals for the controlling the drive circuits to control an individual intensity level of each of the respective emitter circuits.

The control circuit may be configured to determine a number of emitter circuits in the light source in response to the light source type in the configuration data stored in the memory.

The control circuit may be configured to determine an emitter color of each of the emitter circuits in the light source in response to the light source type in the configuration data stored in the memory. The emitter color may indicate a respective color temperature of emitters of one of the emitter circuits when the emitter circuit includes broad-spectrum light-emitting diodes, and indicate a color value of emitters of one of the emitter circuits when the emitter circuit includes non-broad-spectrum light-emitting diodes.

The control circuit may be configured to receive the message including the configuration data having the light source type during a commissioning procedure of a load control system in which the load control device is located.

In some examples, the light source type may indicate a number emitter circuits in the plurality of emitter circuits and/or a type of the light-emitting diodes in each emitter circuit of the plurality of emitter circuits. For example, the light source type may indicate the number of broad spectrum light-emitting diodes in each emitter circuit of the plurality of emitter circuits and/or the number of non-broad spectrum light-emitting diodes in each emitter circuit of the plurality of emitter circuits. For instance, the light source type may indicate whether the light-emitting diodes in each emitter circuit of the plurality of emitter circuits are configured to emit light that is characterized by a color temperature on a black body curve and/or a color value for providing full color control. So, the light source type may indicate whether the light-emitting diodes in each emitter circuit of the plurality of emitter circuit are on the black body curve. Further, the light source type may indicate one or more characteristics of light that is configured to be emitted by the light-emitting diodes in each emitter circuit of the plurality of emitter circuits. Finally, in some examples, the light source type may indicate a form factor of the light source (e.g., indicate whether the light source is configured as tape lighting, track lighting, floor washer lighting, etc.).

### BRIEF DESCRIPTION OF THE DRAWINGS

FIG. 1 depicts an example load control system that includes one or more example remote control devices.

FIG. 2 is a simplified block diagram of an example load control system.

FIG. 3 is a diagram illustrating examples of drive signals generated by a control circuit during a cycle of operation of a driver module.

FIG. 4A is a diagram illustrating examples of drive signals generated by a control circuit during a cycle of operation of a driver module.

FIG. 4B is a diagram illustrating examples of drive signals generated by a control circuit during a cycle of operation of a driver module.

FIG. 5 is a diagram illustrating examples of drive signals generated by a control circuit a during a cycle of an operating period.

FIG. 6 is a diagram illustrating examples of drive signals generated by a control circuit during a cycle of an operating period.

FIG. 7 is a flowchart of an example procedure for controlling a light source at a load control device.

FIG. 8 is a flowchart of an example procedure for controlling a light source at a load control device.

### DETAILED DESCRIPTION

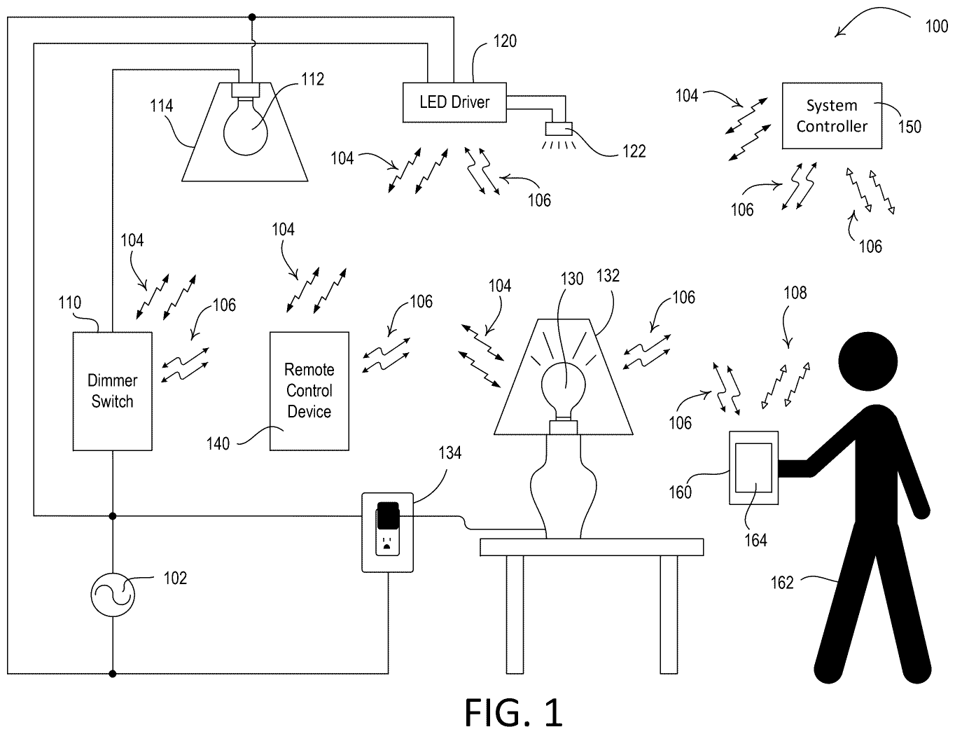

FIG. 1 is a simplified block diagram of an example load control system 100 (e.g., a lighting control system). The load control system 100 may comprise one or more load control devices (e.g., such as lighting control devices) for controlling one or more electrical loads (e.g., such as lighting loads). For example, the load control devices of the load control system 100 may comprise a wall-mounted load control device, such as a dimmer switch 110, which may be electrically coupled between a power source 102 and a light source, such a lighting load 112 (e.g., an external lighting load). The power source 102 may comprise, for example, an alternating-current (AC) power source (e.g., as shown in FIG. 1) and/or a direct-current (DC) power source. The lighting load 112 may comprise a dimmable light source (e.g., such as an incandescent lamp, a halogen lamp, and/or a dimmable light-emitting diode (LED) light source) installed in a lighting fixture 114, such as a ceiling-mounted downlight fixture. The dimmer switch 110 may be configured to control the lighting load 112 using a phase-control dimming technique (e.g., the lighting load 112 may be responsive to a phase-control signal generated by the dimmer switch 110). For example, the dimmer switch 110 may be configured to adjust an intensity level (e.g., a brightness) of the lighting load 112 using the phase-control dimming technique. The dimmer switch 110 may be configured to adjust the intensity level of the lighting load 112 between a low-end intensity level (e.g., a minimum intensity level) and a high-end intensity level (e.g., a maximum intensity level).

The lighting load 112 may be configured to adjust the intensity level of light emitted by the lighting load 112 in response to a firing angle of the phase-control signal received from the dimmer switch 110. In some examples, the lighting load 112 may be configured to also adjust a color (e.g., a color temperature on a black body curve and/or a color value for providing full color control) of the light emitted by the lighting load 112 in response to the phase-control signal according to a relationship between the color temperature and the intensity level set by the phase-control signal (e.g., according to a warm-dim curve). The dimmer switch 110 may comprise a user interface, including one or more buttons configured to be actuated by a user for controlling the lighting load 112. In addition, the dimmer switch 110 may be configured to receive messages (e.g., digital messages) via communication signals, such as wireless signals, e.g., radio-frequency (RF) signals 104, 106. For example, the message may include commands for causing the dimmer switch 110 to control the lighting load 112. In some examples, in addition to generating the phase-control signal, the dimmer switch 110 may be configured to transmit messages including commands for controlling the lighting load 112 (e.g., and/or other lighting loads in the load control system 100). For example, the lighting load 112 may be configured to adjust the intensity level and/or the color (e.g., color temperature and/or color value) of the light emitted by the lighting load 112 in response to the commands received in the messages (e.g., from the dimmer switch 110) via the RF signals 104, 106.

The load control devices of the load control system 100 may also comprise a remotely-located load control device, such as an LED driver 120, for controlling a lighting load, such as LED light source 122 (e.g., an external lighting load). The LED driver 120 may be electrically coupled to the power source 102 for receiving power and may be configured to control the amount of power delivered to the LED light source 122 for controlling an intensity level and/or color (e.g., color temperature and/or color value) of the LED light source 122. For example, the integral LED light source may comprise one more LED circuits of different colors (e.g., wavelengths and/or color temperatures) that may be mixed together to control a cumulative light emitted by the integral LED light source. The LED light source 122 may comprise, for example, an LED light engine that is external to a housing of the LED driver 120 and installed with the LED driver 120 in a lighting fixture 124, such as a ceiling-mounted downlight fixture. For example, the LED driver 120 may be a multi-channel LED driver having multiple channels (e.g., outputs) for controlling the differently-colored LED circuits of the LED light source 122. The LED driver 120 may be configured to control the magnitude of drive currents conducted through each of the LED circuits of the LED light source 122 to control the intensity level and/or color of the light emitted by the LED light source 122. The LED driver 120 may be configured to adjust the intensity level of the LED light source 122 between a low-end intensity level (e.g., a minimum intensity level) and a high-end intensity level (e.g., a maximum intensity level). The LED driver 120 may be configured to receive messages (e.g., digital messages) via the RF signals 104, 106. For example, the message may include commands for causing the LED driver 120 to control the LED light source 122. The LED driver 120 may be configured to adjust the intensity level and/or the color (e.g., color temperature and/or color value) of the light emitted by the LED light source 122 in response to the commands received in the messages via the RF signals 104, 106. In some examples, the LED driver 120 may be integrated into the LED light source 122, and the LED light source 122 may be responsive to the command received in the messages via the RF signals 104, 106.

In addition, the load control devices of the load control system 100 may comprise a controllable light source 130 (e.g., such as a smart lamp or smart bulb). The controllable light source 130 may comprise an integral lighting load (e.g., an integral LED light source) included in the same housing as a load control circuit (e.g., an LED drive circuit) for controlling the integral LED light source. For example, the integral LED light source may comprise one more LED circuits of different colors (e.g., wavelengths and/or color temperatures) that may be mixed together to control a cumulative light emitted by the integral LED light source. The controllable light source 130 may be installed into, for example, a table lamp 132 that may be plugged into an electrical outlet 134 (e.g., an electrical receptacle), which may receive power from the power source 102 for powering the controllable light source 130. For example, the electrical outlet 134 may be electrically coupled to the power source 102 via a toggle switch 136 (e.g., a mechanical switch). When the toggle switch 136 is on (e.g., is in a conductive state), the controllable light source 130 may receive power from the power source 102 (e.g., be powered). When the toggle switch 136 is off (e.g., is in a non-conductive state), the controllable light source 130 may be disconnected from the power source 102 (e.g., be unpowered). The load control circuit of the controllable light source 130 may be configured to control an intensity level (e.g., a brightness) and/or a color (e.g., color temperature and/or color value) of the cumulative light emitted by the integral lighting load. The controllable light source 130 may be configured to receive messages (e.g., digital messages) via the wireless signals, e.g., the RF signals 104, 106. For example, the message may include commands for causing the controllable light source 130 to control the integral lighting load. The controllable light source 130 may be configured to adjust the intensity level and/or the color (e.g., color temperature and/or color value) of the light emitted by the integral LED light source in response to the commands received in the messages via the RF signals 104, 106.

The lighting loads of the load control system 100 (e.g., the lighting load 112 controlled by the dimmer switch 110, the LED light source 122 controlled by the LED driver 120, and/or the LED light source of the controllable light source 130) may be capable of multiple means of control. For example, one or more of the lighting loads may be intensity-control capable when the lighting loads are capable of adjusting the intensity level of the light emitted by the lighting load in response to intensity-adjustment commands. In addition, one or more of the lighting loads may be color-temperature-control capable when the lighting loads are capable of adjusting the color temperature of the light emitted by the lighting load in response to color-temperature-adjustment commands. Further, one or more of the lighting loads may be full-color-control capable when the lighting loads are capable of adjusting the color value of the light emitted by the lighting load in response to full-color-adjustment commands. For example, the lighting load 112 controlled by the dimmer switch 110 may be intensity-control capable (e.g., only intensity-control capable) when the lighting load 110 may be controlled via a phase-control signal (e.g., only via a phase-control signal). In addition, the LED light source 122 controlled by the LED driver 120 and the LED light source of the controllable light source 130 may be intensity-control capable as well as color-temperature-control capable and/or full-color-control capable. For example, some lighting loads may be color-temperature-control capable (e.g., only color-temperature-control capable) when the color of the light emitted by the lighting load may be controlled (e.g., only be controlled) to colors (e.g., white colors) along the black body curve. In addition, some lighting loads may be color-control capable when the color of the light emitted by the lighting load may be controlled to multiple color values (e.g., as determined by an x-chromaticity coordinate and a y-chromaticity coordinate) within a gamut in the red-green-blue (RGB) color space (e.g., the CIE 1931 RGB color space), such that the color of the light emitted by the lighting load is not limited to white colors on the black body curve. Typically, those lighting loads that are full-color-control capable are also color-temperature-control capable. A load control device that is controlling a lighting load that is both color-temperature-control capable and full-color-control capable may operate (e.g., only operate) in one or the other of the color-temperature-control mode or the full-color-control mode at a time.

The load control devices of the load control system 100 (e.g., the dimmer switch 110, the LED driver 120, and/or the controllable light source 130) may be configured to communicate (e.g., transmit and/or receive) messages (e.g., digital message) via wired signals or wireless signals, such as radio-frequency (RF) signals 104, 106. For example, the load control devices may be configured to control the respective lighting loads (e.g., the lighting load 112 controlled by the dimmer switch 110, the LED light source 122 controlled by the LED driver 120, and/or the LED light source of the controllable light source 130) in response to control data (e.g., commands) received in the messages via the RF signals 104, 106. The load control devices may each comprise one or more wireless communication circuits for transmitting and/or receiving messages via the RF signals 104, 106. A first wireless communication circuit of each of the load control devices may be capable of communicating on a first wireless communication link (e.g., a wireless network communication link) and/or communicating using a first wireless protocol (e.g., a wireless network communication protocol, such as the CLEAR CONNECT protocol (e.g., the CLEAR CONNECT A and/or the CLEAR CONNECT X protocols) and/or the THREAD protocol) via the RF signals 104. A second wireless communication circuit of each of the load control devices may be capable of communicating on a second wireless communication link (e.g., a short-range wireless communication link) and/or communicating using a second wireless protocol (e.g., a short-range wireless communication protocol, such as the BLUETOOTH and/or BLUETOOTH LOW ENERGY (BLE) protocols) via the RF signals 106.

The lighting control system 100 may include one or more input control devices for controlling the load control devices (e.g., controlling the intensity levels of the lighting load 112 controlled by the dimmer switch 110, the LED light source 122 controlled by the LED driver 120, and/or the LED light source of the controllable light source 130). For example, the input control devices of the load control system 100 may comprise a remote control device 140. The load control devices (e.g., the dimmer switch 110, the LED driver 120, and/or the controllable light source 130) may be controlled substantially in unison, or be controlled individually. The remote control device 140 may be configured to generate control data (e.g., commands) for controlling the load control devices to turn on and off the lighting load 112 controlled by the dimmer switch 110, the LED light source 122 controlled by the LED driver 120, and/or the controllable light source 130. The remote control device 140 may be configured to generate control data (e.g., commands) for adjusting the intensity levels of the lighting load 112 controlled by the dimmer switch 110, the LED light source 122 controlled by the LED driver 120, and/or the controllable light source 130. The remote control device 140 may be configured to generate control data (e.g., commands) for controlling the color of light emitted by the lighting load 112 and/or the controllable light source 130 (e.g., by controlling a color temperature of the lighting loads or by adjusting a color value of the lighting loads using full-color control). The remote control device 140 may be configured to generate control data (e.g., commands) for controlling the intensity level and/or the color temperature of each of the lighting load 112, the LED light source 122, and the controllable light source 130 to an absolute level (e.g., to a particular intensity level, such as to 50%), and/or by a relative amount (e.g., by a particular amount, such as by 10%). The remote control device 140 may be configured to use full color control to control the color value of each of the lighting load 112, the LED light source 122, and the controllable light source 130 to an absolute level (e.g., to a particular color value).

The remote control device 140 may be configured to be responsive to an input and transmit the control data in one or more messages via the RF signals 104, 106 for controlling the lighting load 112, the LED light source 122, and/or the controllable light source 130 based on the input. For example, the input may comprise a detection of an actuation of a button of the input control device by a user. The control data may include commands and/or other information (e.g., such as identification information) for controlling the lighting load 112, the LED light source 122, and/or the controllable light source 130. In some examples, the dimmer switch 110 may be configured to transmit messages via the RF signals 104, 106 for controlling other lighting loads, such as the LED light source 122 and/or the integral LED light source of the controllable light source 130. The remote control device 140 may be configured to receive an input and may generate and transmit a message (e.g., including control data, such as commands) for controlling the lighting load 112, the LED light source 122, and/or the controllable light source 130 in response to the input. The remote control device 140 may be powered by a direct-current (DC) power source (e.g., a battery or an external DC power supply plugged into an electrical outlet). In some examples, the remote control device 140 may be configured to be electrically connected to the power source 102 for receiving power (e.g., when the remote control device 140 is mounted to the electrical wallbox).

The load control system 100 may also comprise one or more system processing devices, such as a system controller 150, that may be configured to transmit and/or receive messages via wired and/or wireless communications. For example, the system controller 150 may operate as an intermediary device and/or a central processing device for one or more other devices in the load control system 100. The system controller 150 may be configured to communicate messages (e.g., digital messages) to and from the control devices (e.g., the input control devices and the load control devices of the lighting control system 100). The system controller 150 may be configured to receive messages from the input control devices (e.g., the remote control device 140) and transmit messages to the load control devices (e.g., the dimmer switch 110, the LED driver 120, and/or the controllable light source 130) in response to the messages received from the input control devices. The system controller 150 may route the messages based on the association information stored thereon. The messages from the input control devices and/or to the load control devices may be communicated via the RF signals 104, 106.

The system controller 150 may be configured to transmit messages to the load control devices for controlling the lighting loads (e.g., the lighting load 112, the LED light source 122, and/or the LED light source of the controllable light source 130) in response to the messages received from the input control devices (e.g., via the RF signals 104, 106). For example, the system controller 150 may receive a message indicating an actuation of a button from an input control device (e.g., such as the remote control device 140), and transmit a message to one or more of the load control devices for controlling the lighting loads. For example, the input control devices may be configured to control (e.g., indirectly control) the lighting loads (e.g., the lighting load 112, the LED light source 122, and/or the LED light source of the controllable light source 130) by transmitting messages to the system controller 150 that cause the system controller 150 to transmit messages including commands for controlling the lighting loads to the load control devices. Though the system controller 150 is described as communicating messages between devices in the lighting control system 100, messages may be communicated directly between devices (e.g., between the input control devices and/or the load control devices). The messages may include configuration data for configuring the input control devices and/or the load control devices, and/or the messages may include control data (e.g., one or more commands) for controlling the lighting loads.

The system controller 150 may also, or alternatively, be capable of communicating on a third wireless communication link (e.g., a network communication link) and/or communicating using a third wireless protocol (e.g., a network communication protocol, such as Internet protocol, Ethernet-based protocols, WI-FI protocols, or other suitable network protocols), via RF signals 108. For example, the system controller 150 may be configured to transmit and/or receive messages on a network (e.g., a local area network and/or a wide area network, such as the Internet), via the RF signals 108. The system controller 150 may transmit messages to the load control devices in response to messages received via the network. The messages may include configuration data for configuring the load control devices and/or control information (e.g., commands) for controlling the load control devices.

The load control devices (e.g., the dimmer switch 110, the LED driver 120, and/or the controllable light source 130) may be configured to be controlled by one or more of the input control devices (e.g., the remote control device 140) and/or the system controller 150. For example, one or more of the load control devices may be associated with one of the input control devices during a configuration procedure of the lighting control system 100. During normal operation of the lighting control system 100, the load control devices may be responsive to messages received from the input control devices to which the respective load control devices are associated.

The input control devices and/or the system controller 150 may be configured to activate a scene (e.g., a preset) associated with the lighting loads (e.g., the lighting load 112, the LED light source 122, and/or the LED light source of the controllable light source 130). A scene may be associated with one or more predetermined settings of the lighting loads, such as an intensity level and/or a color (e.g., a color temperature and/or a color value) of the lighting loads. The scenes may be configured via the input control devices and/or the system controller 150. The input control devices may be configured to switch between different operational modes. An operational mode may be associated with controlling different types of electrical loads or different operational aspects of one or more electrical loads of the load control system 100 (e.g., electrical loads including and/or other than the lighting loads shown in FIG. 1). Examples of operational modes may include a lighting control mode for controlling one or more lighting loads (e.g., which in turn may include an intensity-adjustment mode, a color-temperature-adjustment mode, and/or a full-color-adjustment mode), an entertainment system control mode (e.g., for controlling music selection and/or the volume of an audio system), an heating, ventilation, and air-conditioning (HVAC) system control mode, a window treatment device control mode (e.g., for controlling one or more shades), and/or the like.

The load control devices (e.g., the dimmer switch 110, the LED driver 120, and/or the controllable light source 130) may be configured to control the respective lighting loads (e.g., the lighting load 112, the LED light source 122, and/or the LED light source of the controllable light source 130) in response to scenes selected by the input control devices and/or the system controller 150 For example, the messages transmitted by the input control devices in response to a scene being selected may include an indication of the selected scene. The load control devices may have stored in memory thereon the particular intensity levels, color temperatures, and/or color values to which to control the respective lighting loads in response to the selected scenes. For example, the load control devices may be configured to provide absolute control of the intensity level, color temperature, and/or color values (e.g., to control the intensity level, color temperature, and/or color values to absolute levels) in response to the selection of scenes. In response to the selection of a particular scene, the load control devices may be configured to control either the color temperature and/or the color value of a particular lighting load that is a part of the scene. For example, the LED driver 120 and/or the controllable light source 130 may be configured to operate in a color-temperature-control mode to control the color temperature of the controlled lighting load, or may operate in a full-color-control mode to control the color value of the controlled lighting load (e.g., as determined by an x-chromaticity coordinate and a y-chromaticity coordinate).

A network device 160 may be in communication with the load control devices and/or the system controller 150 for configuring and/or controlling the control devices of the load control system 100. The network device 160 may comprise a wireless phone, a tablet, a laptop, a personal digital assistant (PDA), a wearable device (e.g., a watch, glasses, etc.), or other computing device. The network device 160 may be operated by a user 162. For example, the network device 160 may comprise a visible display 164 for displaying a graphical user interface (GUI) for displaying information for the user 162 and receiving inputs from the user 162. The network device 160 may be configured to communicate with the load control devices via the RF signals 106 (e.g., using the short-range wireless communication protocol on the short-range wireless communication link). In addition, or alternatively, the network device 160 may be configured to communicate with the system controller 150 via the RF signals 104 (e.g., using the network communication protocol on the network communication link). Further, the network device 160 may be configured to transmit and/or receive beacon signals that may be used to commission the load control system 100 via the short-range wireless communication link (e.g., using the RF signals 106).

The load control devices of the load control system 100 (e.g., the dimmer switch 110, the LED driver 120, and/or the controllable light source 130) may be configured to control the respective lighting loads (e.g., the lighting load 112, the LED light source 122, and/or the LED light source of the controllable light source 130) in response to inputs received from the input devices (e.g., the remote control device 140) and/or the system processing devices (e.g., the system controller 150) based on system configuration data (e.g., programming data and/or association data), which may be stored in a system configuration database. The system configuration database and/or portions of the system configuration database may be stored on one or more of the devices of the loads control system 100. A computing device, such as the network device 160 or other suitable network device, may be configured to define the system configuration data in response to inputs received from the user 162. For example, the network device 160 may be configured to execute a design configuration application (e.g., design configuration software) to display the graphical user interface on the visible display 164 for displaying configuration options and/or receiving the inputs from the user 162 to generate the system configuration data.

After the control devices of the load control system 100 (e.g., the load control devices, the input devices, and/or the system processing devices) are installed, the load control system 100 may be enabled for operation during a commissioning procedure. For example, the network device 160 may be configured to coordinate the commissioning procedure in response to inputs received from the user 162. The network device 160 may be configured to define the system configuration data prior to and/or during the commissioning procedure of the load control system 100. The system configuration data may comprise a device object for each of the control devices in the load control system 100. The device objects of the system configuration data may each comprise one or more of a device name, a device location, a system configuration identifier (e.g., a configuration address), one or more operational settings, and/or programming data. For example, the one or more operational settings may comprise high-end and/or low-end intensity levels (e.g., for a lighting control device), a light source type (e.g., for a lighting control device), raised and/or lowered limit positions (e.g., for a motorized window treatment), a sensitivity level (e.g., for an input device, such as a sensor), etc. The programming data may define how the control devices operate to control the electrical loads of the load control system 100. In addition, each of the device objects of the system configuration data may be configured to store a device identifier (e.g., a unique identifier of the control device of the load control system 100, such as a serial number) that allows the control device of that device object to communicate with the other control devices of the load control system 100. For example, the device identifier of each of the device objects of the system configuration data may be received and stored in the system configuration data during the commissioning procedure.

The control devices of the load control system 100 may be activated (e.g., as a step of the commissioning procedure) to establish the control devices in the load control system 100 (e.g., during an activation process), such that the control devices may be configured to communicate with each other (e.g., via the RF signals 104, 106). During the activation process, the network device 160 may be configured to transmit a discovery initiation message (e.g., a discovery initiation beacon message) to the control devices of the load control system 100. In some examples, the network device 160 may be configured to repetitively (e.g., periodically) transmit the discovery initiation message during the activation procedure. The discovery initiation message may include a discovery initiation identifier, which may be a unique identifier (e.g., a serial number) of the network device 160 and/or the design configuration application executed by the network device 160. In response to receiving the discovery initiation message, the control devices of the load control system 100 may be configured to enter a discovery mode. In some examples, the control devices of the load control system 100 may be configured to enter the discovery mode, when a received signal magnitude (e.g., a received signal strength indicator) of the received discovery initiation message exceeds a discovery threshold. When in the discovery mode, the control devices of the load control system 100 may be configured to transmit a discovery request message (e.g., a discovery request beacon message) to the network device 160. In some examples, the control devices of the load control system 100 may be configured to repetitively (e.g., periodically) transmit the discovery request message while in the discovery mode. The discovery request message may include a device identifier, which may be a unique identifier (e.g., a serial number) of the control device that transmitted the discovery request message. The discovery request message may include a device type (e.g., lighting control device, motorized window treatment, etc.).

After the control devices of the load control system 100 are activated, the system controller 150 and/or the network device 160 may be configured to transmit at least a portion of the system configuration data to each of the control devices in the load control system 100. The network device 160 may be configured to transmit the configuration data to the system controller 150 and the system controller 150 may be configured to transmit portions of the system configuration data to the appropriate control devices of the load control system 100. For example, the system controller 150 may be configured to transmit a portion of the system configuration data that includes a light source type to the LED driver 120, and the LED driver 120 may use the light source type to configure itself for controlling the LED light source 122. For example, the light source type may indicate a number of emitter circuits included in the LED light source 122 and/or an emitter color of the emitters in each of the emitter circuits of the LED light source 122 (e.g., as will be described in greater detail below). For instance, the LED driver 120 may use the light source type to configure a number of drive circuits and/or determine which of the drive circuits to use based on the load source type. Further, in some examples, the LED driver 120 may determine a driver technique based on the load source type (e.g., color temperature control, full-color control, intensity only control, etc.). For examples, the LED driver 120 may determine to use a color temperature control technique is the light source type indicates that the LED light source 122 comprises a tape light strip that is suitable for black body curve control, or determine to use a full-color control technique if the light source type indicates that the LED light source 122 comprises a tape light strip that is suitable for full-color control (e.g., in the RGB color space).

Further, in some examples, the light source type may indicate a number emitter circuits in the plurality of emitter circuits and/or a type of the light-emitting diodes in each emitter circuit of the plurality of emitter circuits. For example, the light source type may indicate the number of broad spectrum light-emitting diodes in each emitter circuit of the plurality of emitter circuits and/or the number of non-broad spectrum light-emitting diodes in each emitter circuit of the plurality of emitter circuits. For instance, the light source type may indicate whether the light-emitting diodes in each emitter circuit of the plurality of emitter circuits are configured to emit light that is characterized by a color temperature on a black body curve and/or a color value for providing full color control. So, the light source type may indicate whether the light-emitting diodes in each emitter circuit of the plurality of emitter circuit are on the black body curve. Further, the light source type may indicate one or more characteristics of light that is configured to be emitted by the light-emitting diodes in each emitter circuit of the plurality of emitter circuits. Finally, in some examples, the light source type may indicate a form factor of the light source (e.g., indicate whether the light source is configured as tape lighting, track lighting, floor washer lighting, etc.).

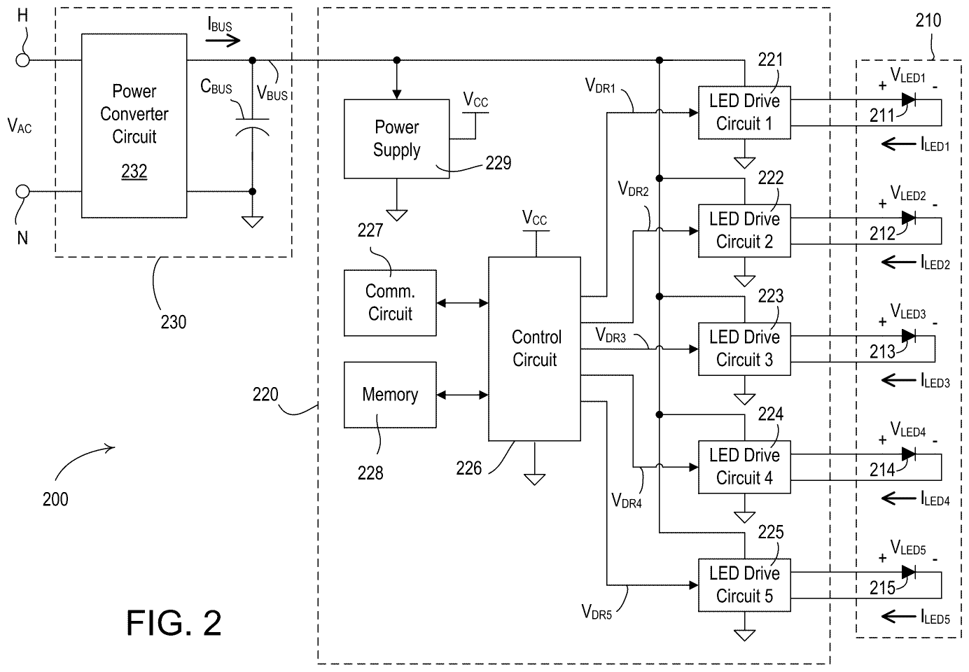

FIG. 2 is a simplified block diagram of an example load control system, such as a light-emitting diode (LED) driver system 200. The LED driver system 200 may comprise a load control device, such as a driver module 220 (e.g., a dimming module), for controlling a light source 210 (e.g., the LED light source 122). The LED driver system 200 may also comprise a power converter module 230 for powering the light source 210 and/or the driver module 220. For example, the light source 210 of the LED driver system 200 may comprise one or more emitter circuits 211, 212, 213, 214, 215 (e.g., LED circuits). Each of the emitter circuits 211-215 may include one or more emitters. The emitters of each emitter circuit 211-215 may be electrically coupled together in series and/or parallel connection. As such, the emitters of each emitter circuit 211-215 may be controlled in unison. The driver module 220 may control the emitter circuits 211-215 to adjust an intensity level (e.g., lighting intensity level and/or brightness) and/or a color (e.g., a color temperature and/or a color value) of a cumulative light emitted by the light source 210. In some examples, the light source 210, the driver module 220, and the power converter module 230 may be separate devices (e.g., housed in separate enclosures and/or fixtures, such as with the LED driver 120 and the LED light source 122 shown in FIG. 1). Further, the light source 210, the driver module 220, and the power converter module 230 may be housed in a single enclosure, or some combination thereof (e.g., when the LED driver system 200 is a controllable light source, such as the controllable light source 130 shown in FIG. 1).

Each of the emitter circuits 211-215 is shown in FIG. 2 as a single LED, but, as noted above, may each comprise a plurality of LEDs connected in series (e.g., a string or chain of LEDs), a plurality of LEDs connected in parallel, or a suitable combination thereof, depending on the particular lighting system. The emitter circuits 211-215 may each represent a string of one or more LEDs, where the LEDs in each string are all configured to emit light at the same color (e.g., color temperature and/or color value). The strings of LEDs represented by each of the emitter circuits 211-215 may be configured to emit light at different colors (e.g., different color temperatures and/or color values). Further, the emitter circuits of the light source 210 are not limited to LEDs, and in some examples, other technology, such as OLEDs may be used. When the light source 210 is strip lighting, each strip of light may be housed separately or may be housed together in one housing or some combination thereof. While the light source 210 is shown as include five emitter circuits 211-215 in FIG. 2, in some examples, the light source 210 may include less than or more than five emitter circuits. For example, the light source 210 may comprise two emitter circuits or three emitter circuits.

Each of the emitter circuits 211-215 may be configured to emit light at a different color (e.g., color temperature and/or color value). For example, one or more of the emitters circuits 211-215 may include broad-spectrum LEDs that may each be configured to produce light (e.g., white light) at a particular color temperature, which may be on the black body curve. For example, one of the emitter circuits 211-215 may represent a string of emitters at a first color temperature T₁ (e.g., a cool-white color temperature, such as approximately 3000 K) and another one of the emitter circuits 211-215 may represent a string of emitters at a second color temperature T₂ (e.g., a warm-white color temperature, such as approximately 1800 K). In some examples, one or more of the emitter circuits 211-215 may include non-broad-spectrum LEDs that may each be configured to produce light at a peak emission wavelength, which may specify the color (e.g., the color value) of the light emitted by the respective emitter circuit. For example, one of the emitter circuits 211-215 may represent a string of red emitters, one of the emitter circuits 211-215 may represent a string of green emitters, and/or one of the emitter circuits 211-215 may represent a string of blue emitters. Although described in context of these colors (e.g., color temperatures and/or color values), the emitter circuits 211-215 may be configured to emit light accordingly to any color (e.g., at any wavelength and/or color temperature).

The power converter module 230 may include a power converter circuit 232, which may receive a source voltage, such as an AC mains line voltage V_{AC}, via a hot connection H and a neutral connection N. The power converter circuit 232 may generate a DC bus voltage V_{BUS} (e.g., approximately 15-50V) across a bus capacitor C_{BUS}. The power converter circuit 232 may be configured to conduct a bus current I_{BUS} for generating the bus voltage V_{BUS} across the bus capacitor C_{BUS}. The power converter circuit 232 may comprise, for example, a boost converter, a buck converter, a buck-boost converter, a flyback converter, a single-ended primary-inductance converter (SEPIC), a Ćuk converter, or any other suitable power converter circuit for generating an appropriate bus voltage. The power converter circuit 232 may provide electrical isolation between the AC power source and the driver module 220 and/or the light source 210. The power converter circuit 232 may also operate as a power factor correction (PFC) circuit to adjust the power factor of the LED driver system 200 towards a power factor of one. Although illustrated as connected to an AC power source (e.g., the AC mains line voltage V_{AC}), in other examples the LED driver system 200 may be coupled to a direct current (DC) power source. Here, the power converter module 230 may not be needed or may convert a DC source voltage of the DC power source to the DC bus voltage V_{BUS} (e.g., at a desired magnitude between approximately 15-50V). The driver module 220 may receive the bus voltage V_{BUS} and conduct current from the bus capacitor C_{BUS} and/or through the power converter module 230. The power converter circuit 232 may be configured to limit the magnitude of the bus current I_{BUS} to a current limit I_{LIMIT} (e.g., approximately 4 A). For example, an overcurrent protection circuit in the power converter circuit 232 may be configured to cause the power converter circuit 232 to stop generating the bus voltage V_{BUS} when the magnitude of the bus current I_{BUS} exceeds the current limit I_{LIMIT}.

The driver module 220 may comprise respective LED drive circuits 221, 222, 223, 224, 225 for controlling (e.g., individually controlling) an amount of power delivered to and an individual intensity level L_{IND1}, L_{IND2}, L_{IND3}, L_{IND4}, L_{IND5} (e.g., lighting intensity level and/or luminous flux) of the light emitted by each of the respective emitter circuits 211-215 of the light source 210. The LED drive circuits 221-225 may receive (e.g., all receive) the bus voltage V_{BUS} (e.g., which may be generated by the power converter circuit 232). Each of the LED drive circuits 221-225 may be configured to adjust (e.g., independently adjust), for example, a magnitude (e.g., an average magnitude) of a respective LED voltage V_{LED1}, V_{LED2}, V_{LED3}, V_{LED4}, V_{LED5} produced across the respective emitter circuit 211-215 (e.g., such that each of the emitter circuits 211-215 may conduct a respective LED current I_{LED1}, I_{LED2}, I_{LED3}, I_{LED4}, I_{LED5}). For example, each of the LED drive circuits 221-225 may be configured to pulse-width modulate (PWM) the respective LED voltage V_{LED1}-V_{LED5} for adjusting the individual intensity level L_{IND1}-L_{IND5} of the light emitted by the respective emitter circuit 211-215. The LED currents I_{LED1}-I_{LED5} conducted by each of the LED drive circuits 221-225 may be configured to have a peak magnitude up to the current limit I_{LIMIT} of the power converter circuit 232 (e.g., without the power converter circuit 232 limiting the magnitude of the LED currents I_{LED1}-I_{LED5}). In some examples, each of the LED drive circuits 221-225 may receive the bus voltage V_{BUS} and may adjust magnitudes (e.g., average magnitudes) of the respective LED currents I_{LED1}-I_{LED5} conducted through the emitter circuits 211-215. For example, each of the LED drive circuits 221-225 may control the respective LED voltages V_{LED1}-V_{LED5} of the emitter circuits 211-215 to the bus voltage V_{BUS} (e.g., based on a PWM technique). Each of the LED circuits 211-215 may comprise a regulation circuit, such as a switching regulator (e.g., a buck converter) for controlling the magnitudes of the respective LED voltages V_{LED1}-V_{LED5} and/or the respective LED drive currents I_{LED1}-I_{LED5}.

The driver module 220 may comprise a control circuit 226 for controlling the LED drive circuits 221-225 to control the individual intensity level L_{IND1}-L_{IND5} of each of the emitter circuits 211-215 of the light source 210. The control circuit 226 may comprise one or more of, for example, a microprocessor, a microcontroller, a programmable logic device (PLD), an application specific integrated circuit (ASIC), a field-programmable gate array (FPGA), or any other suitable processing device or processor.

The control circuit 226 may comprise a core and/or one or more peripherals. The core may include electronic circuitry that executes instructions comprising a computer program(s). The core may perform one or more functions, such as logic, controlling, and input/output (I/O) operations specified by one or more computer programs. The peripherals may be configured to perform one or more functions independent of the core. Each peripheral may be configured with various operational settings. For example, the control circuit 226 may include any combination of a timer peripheral, a peripheral direct memory access (DMA) controller (PDC), a Universal Synchronous/Asynchronous Receiver/Transmitter (USART), a Synchronous Serial Controller (SSC), a Serial Peripheral Interface (SPI), logic gates, flip-flops, filters, latches, etc. The timer peripheral may be configured to maintain and update with respect to time a timer count in order to trigger a specific action after a certain length of time and/or a certain amount of clock cycles. For example, the timer peripheral may be configured to generate timer signals, such as pulse-width modulated (PWM) signals, which may enable control of components and/or circuits external to the control circuit 226 (e.g., for controlling the LED drive circuits 221-225 to generate the respective LED voltage V_{LED1}-V_{LED5}, as will be described in greater detail below). In some examples, the timer peripheral may comprise a buffer (e.g., a dedicated buffer). The peripheral DMA controller may include a first-in first-out (FIFO) buffer with control features for driving one or more software modules included in the control circuit 226 (e.g., universal asynchronous receiver-transmitters (UARTs)).

The control circuit 226 may be configured to control the LED drive circuits 221-225 to control a present intensity level L_{PRES} (e.g., a present brightness) of a cumulative light emitted by the light source 210. For example, the control circuit 226 may be configured to control the present intensity level L_{PRES} of the cumulative light emitted by the light source 110 between a high-end intensity level L_{HE} (e.g., a maximum intensity level, such as approximately 100%) and a low-end intensity level L_{LE} (e.g., a minimum intensity level, such as approximately 0.1%-1.0%)). In addition, the control circuit 226 may be configured to control the LED drive circuits 221-225 to adjust a color (e.g., color temperature and/or color value) of the cumulative light emitted by the light source 210. For example, the control circuit 226 may be configured to control the LED drive circuits 221-225 to adjust a present color temperature T_{PRES} of the cumulative light emitted by the light source 210. Further, the control circuit 226 may be configured to control the LED drive circuits 221-225 to adjust a present color value (e.g., which may be defined by a present x-chromaticity coordinate X_{PRES} and a present y-chromaticity coordinate Y_{PRES}) of the cumulative light emitted by the light source 210. While the LED driver system 200 is described herein with the present color value defined by the present x-chromaticity coordinate X_{PRES} and the present y-chromaticity coordinate Y_{PRES}, the present color value could be defined by other color values (e.g., as defined in other color spaces). For example, the present color value by be a red-green-blue (RGB) color value (e.g., as defined by a red value, a green value, and a blue value, and/or a hex value in the RGB color space) a UVW color value (e.g., as defined by a u-chromaticity value, a v-chromaticity value, and a lightness index (e.g., w) value in the UVW color space), a wavelength, and/or other suitable color value.

In some examples, even though the light source 210 comprises the five emitter circuits 211-215, the control circuit 226 may control the LED drive circuits 221-225 to illuminate less than the five emitter circuits 221-225 (e.g., two to four of the emitter circuits 221-225). For example, the control circuit 221-225 may be configured to control the LED drive circuits 221-225 to illuminate three of the emitter circuits 211-215 to adjust the color (e.g., color temperature and/or color value) of the cumulative light emitted by the light source 210. When illuminating three of the emitter circuits 211-215, the control circuit 221-225 may be configured to generate three of the drive signals V_{DR1}-V_{DR5} for controlling the three of the LED drive circuits 221-225 that are connected to the three of the emitter circuits 211-215 that are illuminated.

While not shown in FIG. 2, the LED drive circuits 221-225 may generate one or more feedback signals that may be received by the control circuit 226 and may indicate magnitudes of respective operating characteristics (e.g., drive currents and/or luminous flux) of the respective emitter circuits 211-215 of the light source 210. In addition, the driver module 220 may comprise one or more feedback circuits (not shown), which may be external to the LED drive circuits 221-225 and may generate the one or more feedback signals that are received by the control circuit 226. The control circuit 226 may control the LED drive circuits 221-225 to adjust the average magnitude of each of the LED voltages V_{LED1}-V_{LED5} towards respective target voltages in response to the feedback signals. In some examples, the control circuit 226 may adjust the average magnitude of each of the LED currents I_{LED1}, I_{LED2} towards respective target currents in response to the feedback signals.

The control circuit 226 may be configured to adjust (e.g., dim) the present intensity level L_{PRES} of the cumulative light emitted by the light source 210 towards a target intensity level L_{TRGT} (e.g., a target brightness), which may range across a dimming range of the controllable lighting device, e.g., between the low-end intensity level L_{LE} and the high-end intensity level L_{HE}. In some examples, the individual intensity level L_{IND1}-L_{IND5} of the light emitted by each of the emitter circuits 211-215 may be dependent upon the magnitude of the LED voltages V_{LED1}-V_{LED5} developed across and/or the LED currents I_{LED1}-I_{LED5} conducted through the emitter circuits 211-215. In addition, the control circuit 120 may be configured to adjust the present color temperature T_{PRES} of the cumulative light emitted by the light source 210 towards a target color temperature T_{TRGT}, which may range between a warm-white color temperature (e.g., approximately 1800 K) and/or a cool-white color temperature (e.g., approximately 3000 K). Further, the control circuit 120 may be configured to adjust the present color value (e.g., as defined by the present x-chromaticity coordinate X_{PRES} and the present y-chromaticity coordinate Y_{PRES}) of the cumulative light emitted by the light source 210 towards a target color value (e.g., as defined by a target x-chromaticity coordinate X_{TRGT} and a target y-chromaticity coordinate Y_{TRGT}).

The LED driver system 200 may comprise a communication circuit 227 coupled to the control circuit 120. The communication circuit 227 may comprise a wired communication circuit. Alternatively or additionally, the communication circuit 227 may comprise a wireless communication circuit, such as, for example, a radio-frequency (RF) transceiver coupled to an antenna for transmitting and/or receiving RF signals. The wireless communication circuit may be an RF transmitter for transmitting RF signals, an RF receiver for receiving RF signals, or an infrared (IR) transmitter and/or receiver for transmitting and/or receiving IR signals. Alternatively or additionally, the communication circuit 227 may be coupled to the hot connection H and the neutral connection N of the LED driver system 200 for transmitting a control signal via the electrical wiring using, for example, a power-line carrier (PLC) communication technique. The control circuit 226 may be configured to receive configuration data and/or control data (e.g., commands) via the message received via the communication circuit 227. The control circuit 226 may be configured receive configuration data that includes a light source type that may be used to configure the control circuit 226 for controlling the light source 210 (e.g., as will be described in greater detail below). For example, the light source type may indicate a number of emitter circuits included in the light source 210 and/or an emitter color of the emitters in each of the emitter circuits of the light source 210. The emitter color may be a color temperature of the emitters in the respective emitter circuit (e.g., when the emitters are broad-spectrum LEDs) or a color value (e.g., as indicated by an x-chromaticity coordinate and a y-chromaticity coordinate) of the emitters in the respective emitter circuit (e.g., when the emitters are non-broad-spectrum LEDs).

The control circuit 226 may be configured to receive and/or determine a commanded intensity level L_{CMD}, a commanded color temperature T_{CMD}, and/or a commanded color value (e.g., as defined by a commanded x-chromaticity coordinate X_{CMD} and a commanded y-chromaticity coordinate Y_{CMD}) from messages (e.g., digital messages) received via the communication circuit 227. The control circuit 226 may be configured to determine the target intensity level L_{TRGT} for the light source 210 in response to the commanded intensity level L_{CMD} from the received message. In addition, control circuit 226 may be configured to determine the target color temperature T_{TRGT} for the light source 210 in response to the commanded color temperature T_{CMD} from the received message. Further, the control circuit 226 may be configured to determine the target x-chromaticity coordinate X_{TRGT} and the target y-chromaticity coordinate Y_{TRGT} for the light source 210 in response to the commanded x-chromaticity coordinate X_{CMD} and the commanded y-chromaticity coordinate Y_{CMD} from the received message, respectively. While not shown in FIG. 2, the driver module 220 may comprise a user interface having one or more actuators (e.g., buttons, sliders, etc.) for receiving user inputs, and the control circuit 226 may be configured to determine the target intensity level L_{TRGT}, the target color temperature T_{TRGT}, and/or the target x-chromaticity coordinate X_{TRGT} and the target y-chromaticity coordinate Y_{TRGT} for the light source 210 in response to actuation of the actuators of the user interface.

The LED driver system 100 may comprise a memory 228 configured to store operational characteristics (e.g., such as operational settings, control parameters, operating modes of the LED driver system 100, etc.), association information for associations with other devices, and/or instructions for controlling electrical loads. For example, the memory 228 may be configured to store the target intensity level L_{TRGT}, the target color temperature T_{TRGT}, the target color value (e.g., as defined by the target x-chromaticity coordinate X_{TRGT} and the target y-chromaticity coordinate Y_{TRGT}), the low-end intensity level L_{LE}, and/or the high-end intensity level L_{HE}. The memory 228 may be implemented as an external integrated circuit (IC) or as an internal circuit of the control circuit 226. The memory 228 may comprise a computer-readable storage media or machine-readable storage media that maintains computer-executable instructions for performing one or more procedure and/or functions as described herein. For example, the memory 228 may comprise computer-executable instructions or machine-readable instructions that when executed by the control circuit configure the control circuit to provide one or more portions of the procedures described herein. The control circuit 226 may access the instructions from the memory 228 for being executed to cause the control circuit 226 to operate as described herein, or to operate one or more other devices as described herein. The memory 228 may comprise computer-executable instructions for executing configuration software. For example, the operational characteristics and/or the association information stored in the memory 228 may be configured during a configuration procedure of the LED driver system 100. The control circuit 226 may be configured to store in the memory 228 configuration data, such as the light source type, that may be received via the communication circuit 227. As mentioned above, the light source type may indicate a number of emitter circuits included in the light source 210, an emitter color (e.g., a color temperature and/or a color value) of the emitters in each of the emitter circuits of the light source 210, and/or a brightness of the emitters. Alternatively or additionally, the light source type may indicate a number emitter circuits in the plurality of emitter circuits and/or a type of the light-emitting diodes in each emitter circuit of the plurality of emitter circuits. For example, the light source type may indicate the number of broad spectrum light-emitting diodes in each emitter circuit of the plurality of emitter circuits and/or the number of non-broad spectrum light-emitting diodes in each emitter circuit of the plurality of emitter circuits. For instance, the light source type may indicate whether the light-emitting diodes in each emitter circuit of the plurality of emitter circuits are configured to emit light that is characterized by a color temperature on a black body curve and/or a color value for providing full color control. So, the light source type may indicate whether the light-emitting diodes in each emitter circuit of the plurality of emitter circuit are on the black body curve. Further, the light source type may indicate one or more characteristics of light that is configured to be emitted by the light-emitting diodes in each emitter circuit of the plurality of emitter circuits. Finally, in some examples, the light source type may indicate a form factor of the light source (e.g., indicate whether the light source is configured as tape lighting, track lighting, floor washer lighting, etc.).

The LED driver system 200 may comprise a power supply 229 that may receive the bus voltage V_{BUS} and generate a supply voltage V_{CC} for powering the control circuit 226 and other low-voltage circuitry of the LED driver system 200.

The control circuit 226 may be configured to generate one or more drive signals V_{DR1}, V_{DR2}, V_{DR3}, V_{DR4}, V_{DR5} for controlling the respective LED drive circuits 221-225. The control circuit 226 may be configured to generate each of the one or more drive signals V_{DR1}-V_{DR5} at an operating frequency for (e.g., approximately 2.05 kHz), such that each of the one or more drive signals V_{DR1}-V_{DR5} are characterized by an operating period T_{OP} (e.g., approximately 488 μsec). The control circuit 226 may be configured to pulse-width modulate one or more of the drive signals V_{DR1}-V_{DR5} (e.g., using the timer peripheral) according to respective duty-cycles d₁-d₅ for controlling the LED drive circuit 221-225, such that the LED voltages V_{LED1}-V_{LED5} have duty cycles that are approximately equal to the respective duty-cycles d₁-d₅ of the drive signals V_{DR1}-V_{DR5}. For example, the control circuit 226 may be configured to adjust the duty cycle d₁ of the first drive signal V_{DR1} to adjust the individual intensity level L_{IND1} of the first emitter circuit 211, adjust the duty cycle d₂ of the second drive signal V_{DR2} to adjust the individual intensity level L_{IND2} of the second emitter circuit 212, adjust the duty cycle d₃ of the third drive signal V_{DR3} to adjust the individual intensity level L_{IND3} of the third emitter circuit 213, adjust the duty cycle d₄ of the fourth drive signal V_{DR4} to adjust the individual intensity level L_{IND4} of the fourth emitter circuit 214, and adjust the duty cycle d₅ of the fifth drive signal V_{DR5} to adjust the individual intensity level L_{IND5} of the fifth emitter circuit 215.

The control circuit 226 may be configured to adjust the duty cycles d₁-d₅ of the respective drive signal V_{DR1}-V_{DR5} to adjust the individual intensity levels L_{IND1}-L_{IND5} of the respective emitter circuits 211-215 while maintaining the operating frequency for and/or the operating period T_{OP} at constant values. The control circuit 226 may be configured to adjust (e.g., independently adjust) the duty cycles d₁-d₅ of one or more of the respective drive signal V_{DR1}-V_{DR5} to adjust the present intensity level L_{PRES}, the present color temperature T_{PRES}, and/or the present color value (e.g., as defined by the present x-chromaticity coordinate X_{PRES} and the present y-chromaticity coordinate Y_{PRES}) of the cumulative light emitted by the light source 110. Based on the duty cycles d₁-d₅, the control circuit 226 may be configured to drive magnitudes of the respective drive signals V_{DR1}-V_{DR5} high towards the supply voltage V_{CC} during respective on times T_{ON1}, T_{ON2}, T_{ON3}, T_{ON4}, T_{ON5} that occur with each operating period T_{OP}.

The LED driver system 200 may be configured to operate with light sources that have different numbers of emitter circuits and/or having emitter circuits of different colors (e.g., wavelengths and/or color temperatures). In some examples, the light source 210 controlled by the LED driver system 200 may comprise two emitter circuits, such as the emitter circuits 211, 212 (e.g., the light source 210 may not comprise the emitter circuits 213, 214, 215). Each of the emitter circuits 211, 212 may include broad-spectrum LEDs configured to emit light (e.g., white light), for example, at a color temperature (e.g., a different color temperature) that is along a black body curve. For example, the first emitter circuit 211 may represent a string of broad-spectrum LEDs at a first color temperature T₁, and the second emitter circuit 212 may represent a string of broad-spectrum LEDs at a second color temperature T₂. The first color temperature may be greater than the second color temperature. For example, the first color temperature may be a cool-white color temperature (e.g., such as approximately 3000 K) and the second color temperature may be a warm-white color temperature (e.g., such as approximately 1800 K). Although described in context of these color temperatures, the emitter circuits 211, 212 may be configured to emit light accordingly to any color temperature. When the light source 210 comprises just the two emitter circuits 211, 212, the emitter circuits 211, 212 may be electrically coupled to and controlled by the first LED drive circuit 221 and the second LED drive circuit 222, respectively (e.g., and the LED drive circuits 223, 224, 225 may be unused when controlling the light source 210). The control circuit 226 may be configured to generate (e.g., only generate) the first drive signal V_{DR1} and the second drive signal V_{DR2} for controlling the first and second LED drive circuits 221, 222, respectively, to control (e.g., only control) the present color temperature T_{PRES} of the cumulative light emitted by the light source 210.

In addition, the light source 210 controlled by the LED driver system 200 may comprise three emitter circuits, such as the emitter circuits 211, 212, 213 (e.g., the light source 210 may not comprise the emitter circuits 214, 215). In a first example, each of the emitter circuits 211, 212, 213 may include broad-spectrum LED configured to emit light (e.g., white light) at a color temperature (e.g., a different color temperature) that is along the black body curve. For example, the first emitter circuit 211 may represent a string of broad-spectrum LEDs at a first color temperature T₁, the second emitter circuit 212 may represent a string of broad-spectrum LEDs at a second color temperature T₂, and the third emitter circuit 213 may represent a string of broad-spectrum LEDs at a third color temperature T₃. In a second example, the first and second emitter circuits 211, 212 may include broad-spectrum LEDs configured to emit light (e.g., white light) at a color temperature (e.g., a different color temperature) that is along the black body curve, while the third emitter circuit 213 may include non-broad-spectrum LEDs configured to emit light, for example, at a color value (e.g., such as a green color value) that is not along the black body curve. In a third example, each of the emitter circuits 211, 212, 213 may include non-broad-spectrum LEDs configured to emit light at a color value (e.g., not limited to white colors on the black body curve). For example, the first emitter circuit 211 may represent a string of non-broad-spectrum LEDs at a first color value (e.g., a red color value), the second emitter circuit 212 may represent a string of non-broad-spectrum LEDs at a second color value (e.g., a blue color value), and the third emitter circuit 213 may represent a string of non-broad-spectrum LEDs at a third color value (e.g., a green color value). When the light source 210 comprises just the three emitter circuits 211, 212, 213, the emitter circuits 211, 212, 213 may be electrically coupled to and controlled by the first LED drive circuit 221, the second LED drive circuit 222, and the third LED drive circuit 223, respectively (e.g., and the LED drive circuits 224, 225 may be unused when controlling the light source 210). The control circuit 226 may be configured to generate (e.g., only generate) the first drive signal V_{DR1}, the second drive signal V_{DR2}, and the third drive signal V_{DR3} for controlling the first, second, and third LED drive circuits 221, 222, 223, respectively, to control the present color temperature T_{PRES} and/or the present color value (e.g., as defined by the present x-chromaticity coordinate X_{PRES} and the present y-chromaticity coordinate Y_{PRES}) of the cumulative light emitted by the light source 210.

Further, the light source 210 controlled by the LED driver system 200 may comprise five emitter circuits, such as the emitter circuits 211-215 (e.g., as shown in FIG. 2). For example, the two of the emitter circuits 211-215 may include broad-spectrum LEDs configured to emit light (e.g., white light) at a color temperature (e.g., a different color temperature) that is along the black body curve, and three of the emitter circuits 211-215 may include non-broad-spectrum LEDs configured to emit light at a color value (e.g., not limited to white colors on the black body curve). For example, the first emitter circuit 211 may represent a string of broad-spectrum LEDs at a first color temperature T₁ and the second emitter circuit 212 may represent a string of broad-spectrum LEDs at a second color temperature T₂. In addition, the third emitter circuit 213 may represent a string of non-broad-spectrum LEDs at a first color value (e.g., a red color value), the fourth emitter circuit 214 may represent a string of non-broad-spectrum LEDs at a second color value (e.g., a blue color value), and the fifth emitter circuit 215 may represent a string of non-broad-spectrum LEDs at a third color value (e.g., a green color value). When the light source 210 comprises all five of the emitter circuits 211-215 (e.g., as shown in FIG. 2), the emitter circuits 211-215 may be electrically coupled to and controlled by the respective LED drive circuits 221-225. The control circuit 226 may be configured to generate the drive signals V_{DR1}-V_{DR5}, and the third drive signal V_{DR3} for controlling the respective LED drive circuits 211-215 to control the present color temperature T_{PRES} and/or the present color value (e.g., as defined by the present x-chromaticity coordinate X_{PRES} and the present y-chromaticity coordinate Y_{PRES}) of the cumulative light emitted by the light source 210.

The control circuit 226 may be configured to operate in either a color-temperature-control mode or a full-color-control mode to control either the present color temperature T_{PRES} or the present color value (e.g., as defined by the present x-chromaticity coordinate X_{PRES} and the present y-chromaticity coordinate Y_{PRES}), respectively. When operating in the color-temperature-control mode, the control circuit 226 may be configured to control the LED drive circuits 221-225 to adjust the present color temperature T_{PRES} of the cumulative light emitted by the light source 210 towards the target color temperature T_{TRGT}. When operating in the full-color-control mode, the control circuit 226 may be configured to control the LED drive circuits 221-225 to adjust the present x-chromaticity coordinate X_{PRES} and the present y-chromaticity coordinate Y_{PRES} (e.g., that define the present color) of the cumulative light emitted by the light source 210 towards the target x-chromaticity coordinate X_{TRGT} and the target y-chromaticity coordinate Y_{TRGT} (e.g., that define the target color). The control circuit 226 may be configured to determine to operate in one of the color-temperature-control mode or the full-color-control mode based on the last color-adjustment command received in a message via the communication circuit 227. For example, the control circuit 226 may be configured to operate in the color-temperature-control mode when the last received color-adjustment command is a color-temperature-adjustment command including a commanded color temperature T_{CMD}, and in the full-color-control mode when the last received color-adjustment command is a full-color-adjustment command including a commanded color value (e.g., as defined by a commanded x-chromaticity coordinate X_{CMD}) and a commanded y-chromaticity coordinate Y_{CMD}).

The control circuit 226 may be configured to determine which of the emitter circuits 211-215 to control based on the color-control mode in which the control circuit is presently operating and/or the light source type that is stored in the memory 228. When the LED driver system 200 has a greater number of LED drive circuits 221-225 than the number of emitter circuits of the light source 210 (e.g., when the light source 210 has less than five emitter circuits), the control circuit 226 may be configured to determine which of the LED drive circuits 221-225 to control based on the number of the number of emitter circuits in the light source 210 as indicated by the light source type. For example, when the light source 210 has two emitter circuits, the control circuit 226 may be configured to determine to generate the first and second drive signals V_{DR1}-V_{DR2} to control the first and second LED drive circuits 221-222, respectively, to adjust the present color temperature T_{PRES} of the cumulative light emitted by the light source 210 to the target color temperature T_{TRGT} (e.g., when in the color-temperature-control mode). In addition, when the light source 210 has three emitter circuits, the control circuit 226 may be configured to determine to generate the first, second, and third drive signals V_{DR1}-V_{DR3} to control the first, second, and third LED drive circuits 221-223, respectively, to adjust the present color temperature T_{PRES} of the cumulative light emitted by the light source 210 to the target color temperature T_{TRGT} (e.g., when in the color-temperature-control mode) and/or to adjust the present color value of the cumulative light emitted by the light source 210 to the target color value (e.g., when in the full-color-control module).

In some examples, the control circuit 226 may control the LED drive circuits 221-225 to illuminate less than the five emitter circuits 221-225 (e.g., three or four of the emitter circuits 211-215) based on the color-control mode in which the control circuit is presently operating and/or the emitter color of the emitters in each of the emitter circuits of the light source 210. For example, when the light source 210 includes five emitter circuits 211-215, where two of the emitter circuits include broad-spectrum LEDs configured to emit light at different color temperatures and three of the emitter circuits include non-broad-spectrum LEDs configured to emit light at different color values, the control circuit 226 may be configured to determine to control (e.g., only control) three of the emitter circuits 211-215 to adjust the present color temperature T_{PRES} of the cumulative light emitted by the light source 210 to the target color temperature T_{TRGT} when in the color-temperature-adjustment mode and to adjust the present color of the cumulative light emitted by the light source 210 to the target color when in the full-color-control mode. When operating in the color-temperature-control mode, the control circuit 226 may be configured to determine to control three of the LED drive circuits 221-225 to illuminate the two of the emitter circuits that are configured to emit light at different color temperatures and one of the emitter circuits that are configured to emit light at different color values. In addition, when operating in the full-color-control mode, the control circuit 210 may be configured to determine to control three of the LED drive circuits 221-225 to illuminate the three of the emitter circuits that are configured to emit light at different color values when operating in the full-color-control mode.

The control circuit 226 may be configured to determine the duty cycles d₁-d₅ for the respective drive signals V_{DR1}-V_{DR5} based on which of the five LED drive circuits 221-225 that the control circuit 226 has determined to control (e.g., based on the color-control mode in which the control circuit is presently operating and/or based on the light source type, as described above). In addition, the control circuit 226 may be configured to determine the duty cycles d₁-d₅ for the respective drive signals V_{DR1}-V_{DR5} based on either the target color temperature T_{TRGT} (e.g., when operating in the color-temperature-control mode) or the target x-chromaticity coordinate X_{TRGT} and the target y-chromaticity coordinate Y_{TRGT} (e.g., when operating in the full-color-control mode). The determined duty cycles d₁-d₅ for the respective drive signals V_{DR1}-V_{DR5} may define ratios between the individual intensity level L_{IND1}-L_{IND5} of the respective emitter circuits 211-215 to cause the cumulative light emitted by the light source 210 to be controlled towards the target color temperature T_{TRGT} (e.g., when operating in the color-temperature-control mode) or the target color value as defined by the target x-chromaticity coordinate X_{TRGT} and the target y-chromaticity coordinate Y_{TRGT} (e.g., when operating in the full-color-control mode). When the control circuit 226 has determined to control less than the five LED drive circuits 221-225, the control circuit 226 may be configured to set the duty cycles d₁-d₅ for the respective drive signals V_{DR1}-V_{DR5} for those of the LED drive circuits 221-225 that are not being controlled to 0%. In some examples, the control circuit 226 may be configured to determine the duty cycles d₁d₅ for the respective drive signals V_{DR1}-V_{DR5} based on the brightness of the emitters.

When the target intensity level L_{TRGT} of the cumulative light emitted by the light source 210 is at the high-end intensity level L_{HE} (e.g., approximately 100%), the control circuit 226 may set the duty cycles d₁-d₅ such that the sum of the duty cycles d₁-d₅ may be approximately 100% (e.g., the sum of the on times T_{ON1}-T_{ON5} may be approximately equal to the operating period T_{OP}). The control circuit 226 may be configured to generate the drive signals V_{DR1}-V_{DR5} such that the on times T_{ON1}-T_{ON5} do not overlap in time within each cycle of the operation period T_{OP}. Since the on times T_{ON1}-T_{ON5} of the drive signals V_{DR1}-V_{DR5} do not overlap in time, the LED drive circuits 221-225 may each conduct the respective LED current I_{LED1}-I_{LED5} having a peak magnitude up to the current limit I_{LIMIT} of the power converter circuit 232 (e.g., without the power converter circuit 232 limiting the magnitude of the LED currents I_{LED1}-I_{LED5}). In some examples, the control circuit 226 may be configured to generate the drive signals V_{DR1}-V_{DR5} such that the on times T_{ON1}-T_{ON5} have no more than a maximum overlap time T_{OL-MAX} (e.g., as will be described in greater detail below).

When the target intensity level L_{TRGT} of the cumulative light emitted by the light source 210 is less than the high-end intensity level L_{HE}, the control circuit 226 may be configured to scale the duty cycles (e.g., the duty cycles d₁-d₅ when the target intensity level L_{TRGT} is at the high-end intensity level L_{HE}) by the target intensity level L_{TRGT}, such that the ratios between the individual intensity level L_{IND1}-L_{IND5} of the respective emitter circuits 211-215 are maintained constant. When the target intensity level L_{TRGT} is less than the high-end intensity level L_{HE}, the sum of the duty cycles d₁-d₅ may be less than 100% (e.g., the sum of the on time T_{ON1}-T_{ON5} may be less than the operating period T_{OP}), such that a dead time T_{DT} exists during the operating period T_{OP}. For example, the dead time T_{DT} may be equal to the difference between the operating period T_{OP} and the sum of the on times T_{ON1}-T_{ON5}, e.g.,

$${T}_{DT} = {T}_{OP} - ( {T}_{ON 1} + {T}_{ON 2} + {T}_{ON 3} + {T}_{ON 4} + {T}_{ON 5} ) .$$

During the dead time T_{DT}, the control circuit may be configured to drive the magnitudes of the drive signals V_{DR1}-V_{DR5} (e.g., all of the drive signals) low (e.g., towards circuit common).

The control circuit 226 may use the timer peripheral to generate the drive signals V_{DR1}-V_{DR5} for controlling the LED drive circuits 221-225. For example, the control circuit 226 may use five channels of the timer peripheral to generate (e.g., independently generate) the respective drive signals V_{DR1}-V_{DR5} (e.g., one channel for each of the drive signals V_{DR1}-V_{DR5}). The control circuit 226 may configure the timer peripheral to generate the drive signals V_{DR1}-V_{DR5} as pulse-width modulated (PWM) signals. The control circuit 226 may be configured to set a timer period T_{TIM} of the periodic operation of the timer peripheral for generating the pulse-width modulated signals (e.g., the drive signals V_{DR1}-V_{DR5}), such that the pulse-width modulated signals may have time slots (e.g., periodic time slots). As described in more detail herein, the control circuit 226 may configure a capture/compare register of each of the channels of the timer peripheral to set the on times T_{ON1}-T_{ON5} (e.g., and thus the duty cycles d₁-d₅) of the drive signals V_{DR1}-V_{DR5}. In addition, the control circuit 226 may configure each of the channels of the timer peripheral to be driven high (e.g., towards the supply voltage V_{CC}) at the beginning of each timer period T_{TIM} and then low (e.g., towards circuit common) at the end of each timer period T_{TIM}, or driven low (e.g., towards circuit common) at the beginning of each timer period T_{TIM} and then high (e.g., towards the supply voltage V_{CC}) at the end of each timer period T_{TIM}.

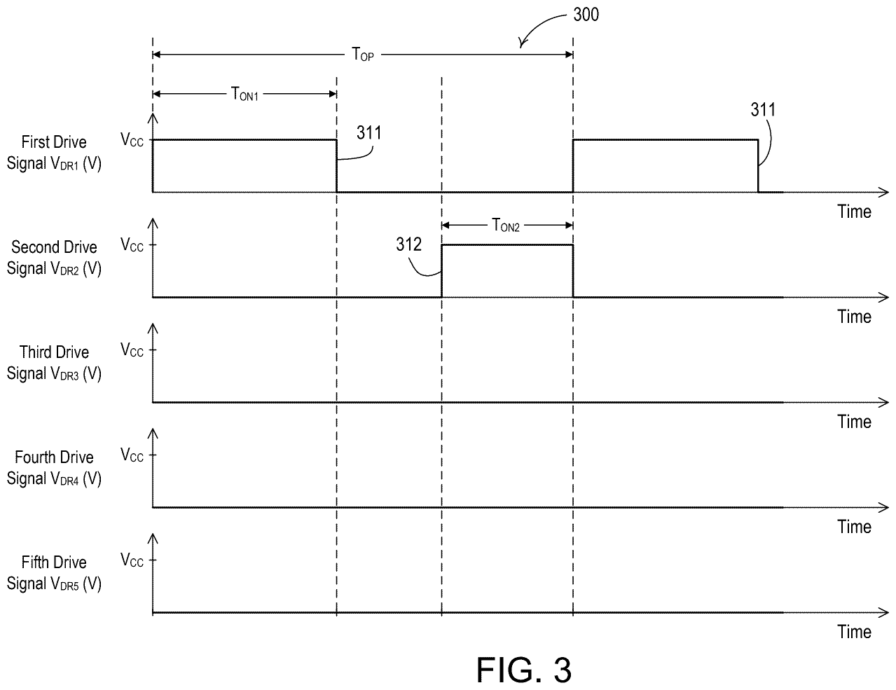

FIG. 3 is a diagram illustrating examples of the drive signals V_{DR1}-V_{DR5} generated by the control circuit 226 during a cycle 300 of operation of the driver module 220, for example, when the light source 210 comprises two emitter circuits (e.g., the emitter circuits 211-212). For example, the first emitter circuit 211 may represent a string of broad-spectrum LEDs at a first color temperature T₁ (e.g., a cool-while color temperature, such as approximately 3000 K) and the second emitter circuit 212 may represent a string of broad-spectrum LEDs at a second color temperature T₂ (e.g., a warm-white color temperature, such as approximately 1800 K). The control circuit 226 may be configured to generate the first and second drive signals V_{DR1}-V_{DR2} for controlling the first and second LED drive circuits 221-222, respectively, to adjust the present color temperature T_{PRES} of the cumulative light emitted by the light source 210 to the target color temperature T_{TRGT} (e.g., when in the color-temperature-control mode). The control circuit 226 may be configured to control the LED drive circuits 211-222 to generate pulses 311-312 having respective on times T_{ON1}-T_{ON5}. The control circuit 226 may be configured to control the third, fourth, and fifth drive signals V_{DR3}-V_{DR5} to be driven low (e.g., towards approximately circuit common) throughout each cycle 300. For example, the control circuit is configured to control the generation of the drive signals V_{DR1}-V_{DR2} at the operating frequency for, such that the drive signals V_{DR1}-V_{DR2} repeat during each cycle 300 of the operation period T_{OP}.

The control circuit 226 may configure the timer peripheral to generate the drive signals V_{DR1}-V_{DR2} as pulse-width modulated signals using two of the channels of the timer peripheral. The control circuit 226 may be configured to set the timer period T_{TIM} to be the same for both of the channels (e.g., such that the first and second drive signals V_{DR1}-V_{DR2} are generated in the same time slot of the timer peripheral operation). For example, the timer period T_{TIM} may be equal to the operating period T_{OP} of the drive signals V_{DR1}-V_{DR2}. The control circuit 226 may configure the first channel (e.g., for generating the first drive signal V_{DR1}) to be driven high (e.g., towards the supply voltage V_{CC}) at the beginning of each timer period T_{TIM} and then low (e.g., towards circuit common) at the end of each timer period T_{TIM}, and configure the second channel (e.g., for generating the second drive signal V_{DR2}) to driven low (e.g., towards circuit common) at the beginning of each timer period T_{TIM} and then high (e.g., towards the supply voltage V_{CC}) at the end of each timer period T_{TIM}.

The control circuit 226 may be configured to determine the duty cycles d₁-d₂ for the respective drive signals V_{DR1}-V_{DR2} based on the target color temperature T_{TRGT} and/or the target intensity level L_{TRGT} for the light source 210. For example, as shown in FIG. 3, the target intensity level L_{TRGT} may be less than the high-end intensity level L_{HE}. To determine the duty cycles d₁-d₂ for the respective drive signals V_{DR1}-V_{DR2} when the target intensity level L_{TRGT} is less than the high-end intensity level L_{HE}, the control circuit 226 may determine the duty cycles d₁-d₂ of the respective drive signals V_{DR1}-V_{DR2} when the target intensity level L_{TRGT} is at the high-end intensity level L_{HE}, and scale the duty cycles d₁-d₂ by the target intensity level L_{TRGT} (e.g., d₁=L_{TRGT}·d₁, and d₂=L_{TRGT}·d₂), such that the ratios between the individual intensity level L_{IND1}-L_{IND2} of the respective emitter circuits 211-212 are maintained constant. The control circuit 226 may configure the capture/compare registers of the first and second channels of the timer periphery to generate the drive signals V_{DR1}-V_{DR2} with the determined duty cycles d₁-d₂ (e.g., as shown in FIG. 2). When the target intensity level L_{TRGT} is less than the high-end intensity level L_{HE}, the sum of the duty cycles d₁-d₂ may be less than 100% (e.g., the sum of the on times T_{ON1}-T_{ON2} may be less than the operating period T_{OP}). The dead time T_{DT} may extend between the on times T_{ON1}-T_{ON2} of the drive signals V_{DR1}-V_{DR2}, such that the sum of the on times T_{ON1}-T_{ON2} is equal to the operating period T_{OP}. During the dead time T_{DT}, the control circuit 226 may be configured to drive the magnitudes of the drive signals V_{DR1}-V_{DR2} low (e.g., towards circuit common). When the target intensity level L_{TRGT} changes, the control circuit 226 may reconfigure the capture/compare registers of the first and second channels of the timer periphery, such that the control circuit 226 may generate the drive signals V_{DR1}-V_{DR2} with different duty cycles d₁-d₂ during a subsequent cycle of the operation period T_{OP}. As shown in FIG. 3, the on times T_{ON1}-T_{ON2} of the drive signals V_{DR1}-V_{DR2} may be non-overlapping.

When the light source 210 comprises more than two emitter circuits, the control circuit 226 may generate the drive signals V_{DR1}-V_{DR5}, such the drive signals V_{DR1}-V_{DR5} include more than two on times during each cycle of the operating period T_{OP}. For example, each cycle of an operating period T_{OP} may include more than two on-times, where each on time may correspond to a drive signal V_{DR1}-V_{DR5}. For example, when the light source 210 comprises three emitter circuits (e.g., the emitter circuits 211, 212, 213), the control circuit 226 may be configured to generate the first, second, and third drive signals V_{DR1}-V_{DR3} for controlling the first, second, and third LED drive circuits 221-223, respectively, such that the drive signals V_{DR1}-V_{DR3} include the three on times T_{ON1}-T_{ON3} during each of the cycles of the operation period T_{OP}. In addition, when the light source 210 comprises the five emitter circuits 211-215 (e.g., as shown in FIG. 2), the control circuit 226 may be configured to generate the drive signals V_{DR1}-V_{DR5} for controlling the LED drive circuits 221-225, respectively, such that the drive signals V_{DR1}-V_{DR5} include the five on times T_{ON1}-T_{ON5} within each of the cycles of the operation period T_{OP}.

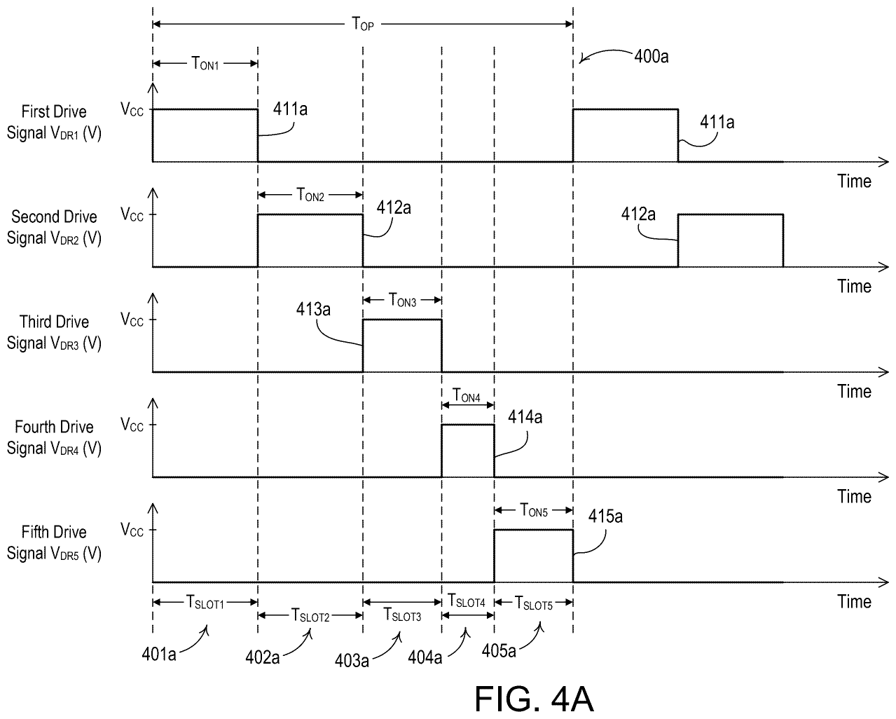

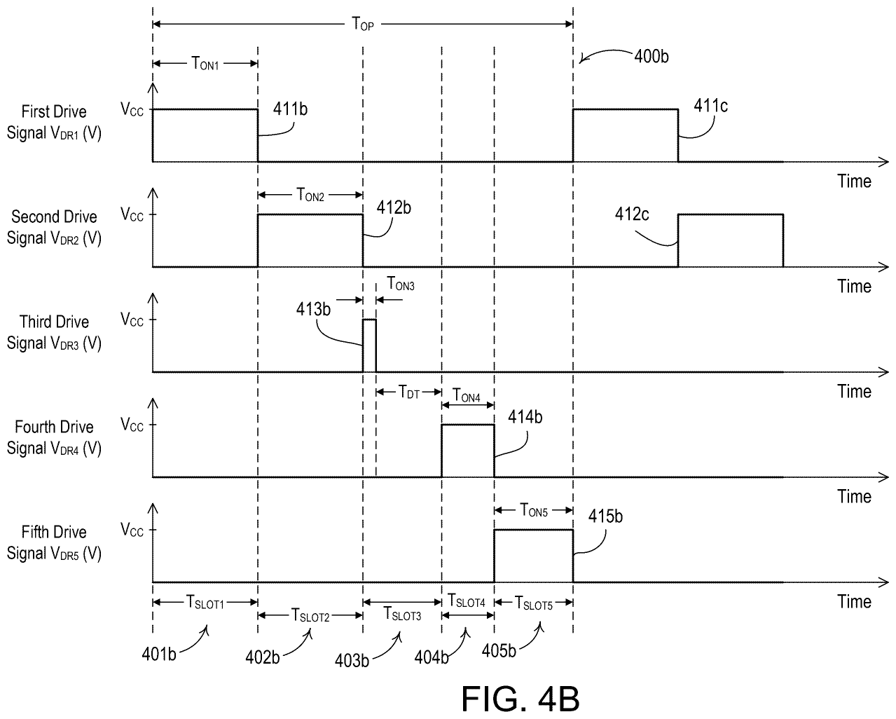

FIG. 4A is a diagram illustrating examples of the drive signals V_{DR1}-V_{DR5} generated by the control circuit 226 during a cycle 400a of operation of the driver module 220, for example, when the control circuit 226 is controlling all of the five LED drive circuit 221-225 to control the light source 210. For example, the light source 210 may comprise five emitter circuits (e.g., the emitter circuits 211-215 as shown in FIG. 2). The control circuit 226 may be configured to control the LED drive circuits 221-225 to generate pulses 411a-415a having respective on times T_{ON1}-T_{ON5} during respective time slots 401a-405a of the cycle 400a. When the target intensity level L_{TRGT} of the cumulative light emitted by the light source 210 is at the high-end intensity level L_{HE} (e.g., approximately 100%), the duty cycles d₁-d₅ may be sized such that the duty cycles d₁-d₅ add up to approximately 100% (e.g., the sum of the on times T_{ON1}-T_{ON5} may be approximately equal to the operating period T_{OP}). As shown in FIG. 4A, the control circuit 226 may be configured to control the drive signals V_{DR1}-V_{DR5} such that the pulses 411a-415a are non-overlapping (e.g., substantially non-overlapping). Each of the time slots 401a-405a may be characterized by a respective slot time T_{SLOT1}, T_{SLOT2}, T_{SLOT3}, T_{SLOT4}, T_{SLOT5}. The time slots 401a-405a may extend across the cycle 400a of the operating period T_{OP}, (e.g., such that the sum of the slot times T_{SLOT1}-T_{SLOT5} may be equal to the operating period T_{OP}). When the target intensity level L_{TRGT} of the cumulative light emitted by the light source 210 is at the high-end intensity level L_{HE}, the on times T_{ON1}-T_{ON5} of the respective drive signals V_{DR1}-V_{DR5} may each be approximately equal to the slot times T_{SLOT1}-T_{SLOT5} of the respective time slots 401a-405a.

While only one full cycle 400a of the operating period T_{OP} is shown in FIG. 4A, the control circuit 226 may be configured to generate the drive signals V_{DR1}-V_{DR5} in the same way during subsequent cycles as shown during the operating period T_{OP} in FIG. 4A when the target color temperature T_{TRGT} and/or the target intensity level L_{TRGT} are in steady-state conditions. When the target color temperature T_{TRGT} and/or the target intensity level L_{TRGT} for the light source 210 change, the control circuit 226 may be configured to adjust the generation of the drive signals V_{DR1}-V_{DR5} from one cycle of the operating period T_{OP} to the next after which the generation the drive signals V_{DR1}-V_{DR5} may repeat on a periodic basis while the target color temperature T_{TRGT} and/or the target intensity level L_{TRGT} are in steady-state conditions.

FIG. 4B is a diagram illustrating examples of the drive signals V_{DR1}-V_{DR5} generated by the control circuit 226 during a cycle 400b of operation of the driver module 220, for example, when the target intensity level L_{TRGT} is less than the high-end intensity level L_{HE}. The control circuit 226 may be configured to control the LED drive circuits 221-225 to generate pulses 411b-415b having respective on times T_{ON1}-T_{ON5} during respective time slots 401b-405b of the cycle 400b. When the target intensity level L_{TRGT} of the cumulative light emitted by the light source 210 is less than the high-end intensity level L_{HE}, the control circuit 226 may be configured to generate the drive signals V_{DR1}-V_{DR5} such that at least one of the on times T_{ON1}-T_{ON5} is less than the slot time T_{SLOT1}-T_{SLOT5} of the respective time slot 401b-405b. As shown in FIG. 4B, the on times T_{ON1}-T_{ON5} may be non-overlapping (e.g., substantially non-overlapping) and the sum of the slot times T_{SLOT1}-T_{SLOT5} may be equal to the operating period T_{OP}.

To determine the duty cycles d₁-d₅ for the respective drive signals V_{DR1}-V_{DR5} when the target intensity level L_{TRGT} is less than the high-end intensity level L_{HE}, the control circuit 226 may be configured to scale the duty cycles by the target intensity level L_{TRGT} (e.g., d₁=L_{TRGT}·d₁; d₂=L_{TRGT}·d₂; d₃=L_{TRGT}·d₃; d₄=L_{TRGT}·d₄; and d₅=L_{TRGT}·d₅), such that the ratios between the individual intensity level L_{IND1}-L_{IND5} of the respective emitter circuits 211-215 are maintained constant. As a result, at least one of the time slots 401b-405b may comprise a dead time T_{DT} during which the control circuit does not drive any of the drive signals V_{DR1}-V_{DR5} high towards the supply voltage V_{CC}. For example, the control circuit 226 may be configured to add the dead time T_{DT} to the one of the time slots 401b-405b that has the shortest respective one of the on times T_{ON1}-T_{ON5}. As shown in FIG. 4B, the dead time T_{DT} may occur, for example, during the third time slot 403b, such that the sum of the on time T_{ON3} of the third drive signal V_{DR3} and the dead time T_{DT} is approximately equal to the slot time T_{SLOT3} of the third time slot 403b. While the dead time T_{DT} is shown in the third time slot 403b in FIG. 4B, the dead time T_{DT} may also be located in any of the time slots 401b-405b. In addition, multiple time slots may include periods of dead time.

In some examples, the control circuit 226 may control less than all of the five LED drive circuits 221-225 to control the light source 210. For example, the control circuit 226 may determine to control less than the five LED drive circuits 221-225 based on the number of the number of emitter circuits in the light source 210 (e.g., when the light source 210 includes less than the five emitter circuits 211-215). In addition, the control circuit 226 may determine to control less than the five LED drive circuits 221-225 based on the color-control mode in which the control circuit is presently operating and/or the emitter color of the emitters in each of the emitter circuits of the light source 210.

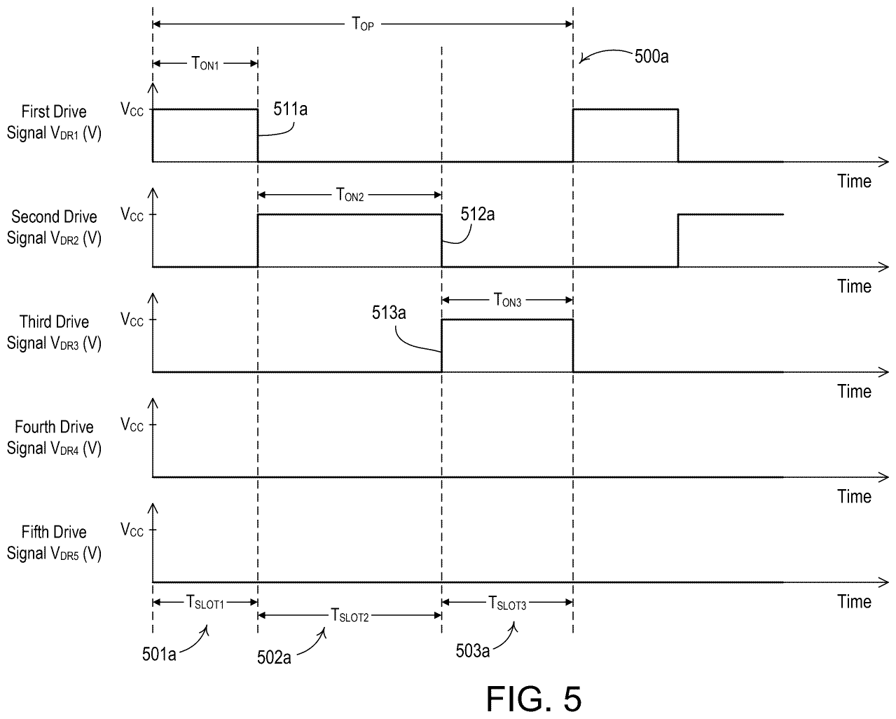

FIG. 5 is a diagram illustrating examples of the drive signals V_{DR1}-V_{DR3} generated by the control circuit 226 during a cycle 500a of the operating period T_{OP}, for example, when the control circuit 226 is controlling three of the LED drive circuits 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-223) based on the color-control mode in which the control circuit is presently operating and/or the emitter color of the emitters in each of the emitter circuits of the light source 210. The control circuit 226 may be configured to control the LED drive circuits 221-223 to generate pulses 511a-513a having respective on times T_{ON1}-T_{ON3} during respective time slots 501a-503a of the cycle 500a. The control circuit 226 may be configured to control the fourth and fifth drive signals V_{DR4}-V_{DR5} to be driven low (e.g., towards approximately circuit common). Each of the time slots 501a-503a may be characterized by a respective slot time T_{SLOT1}, T_{SLOT2}, T_{SLOT3}. The time slots 501a-503a may extend across the length of the operating period T_{OP}, (e.g., such that the sum of the slot times T_{SLOT1}-T_{SLOT3} may be equal to the operating period T_{OP}).

As shown in FIG. 5, the control circuit 226 may be configured to generate the drive signals V_{DR1}-V_{DR3} such that the pulses 511a-513a are non-overlapping (e.g., substantially non-overlapping). When the target intensity level L_{TRGT} of the cumulative light emitted by the light source 210 is at the high-end intensity level L_{HE}, the duty cycles d₁-d₃ of the drive signals V_{DR1}-V_{DR3} may be sized such that the duty cycles d₁-d₃ add up to approximately 100% (e.g., the sum of the on time T_{ON1}-T_{ON3} may be approximately equal to the operating period T_{OP}). When the target intensity level L_{TRGT} of the cumulative light emitted by the light source 210 is at the high-end intensity level L_{HE}, the on times T_{ON1}-T_{ON3} of the respective drive signals V_{DR1}-V_{DR5} may each be approximately equal to the slot times T_{SLOT1}-T_{SLOT3} of the respective time slots 501-503. While FIG. 5 is shown with the control circuit 226 generating the drive signals V_{DR1}-V_{DR3} to control the first, second, and third LED drive circuits 221-223, the control circuit 226 could generate the appropriate drive signals to control any three of the LED drive circuits 221-225 (e.g., depending upon which of the emitter circuits 211-215 of the light source 210 the driver module 220 needs to control).

When the target intensity level L_{TRGT} of the cumulative light emitted by the light source 210 is less than the high-end intensity level L_{HE}, the control circuit 226 may be configured to generate the drive signals V_{DR1}-V_{DR3} such that at least one of the on times T_{ON1}-T_{ON3} is less than the slot time T_{SLOT1}-T_{SLOT3} of the respective time slot 501a-503a. While not shown in FIG. 5, the control circuit 226 may also be configured to generate the drive signals V_{DR1}-V_{DR3} such that at least one of the time slots 501a-503a may comprise a dead time T_{DT} during which the control circuit does not drive any of the drive signals V_{DR1}-V_{DR3} high towards the supply voltage V_{CC}. For example, the control circuit 226 may be configured to add the dead time T_{DT} to the one of the time slots 501a-503a that has the shortest respective one of the on times T_{ON1}-T_{ON3} (e.g., in a similar manner as shown in FIG. 4B and described above).

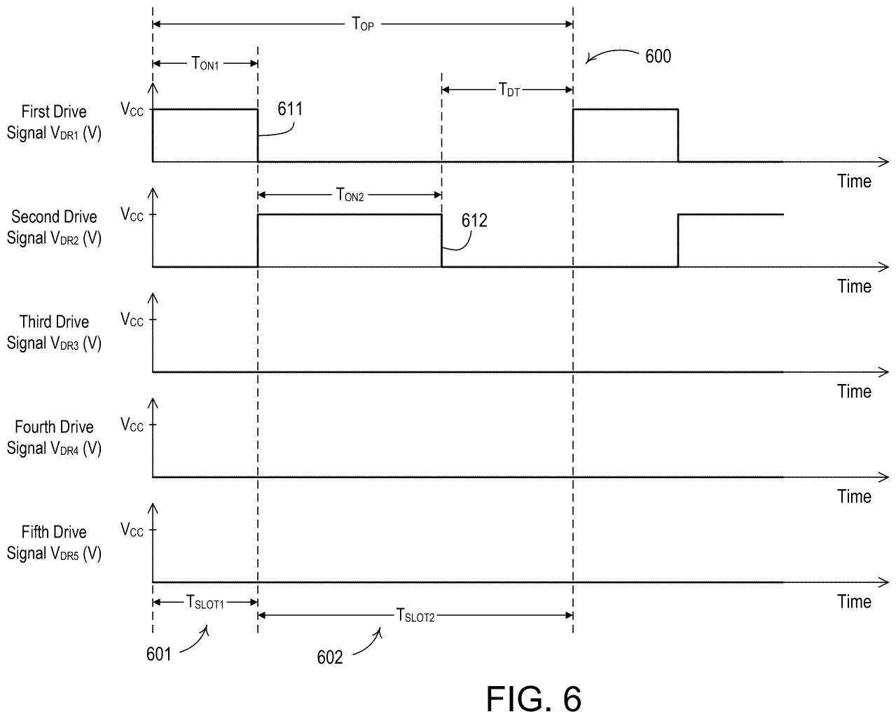

FIG. 6 is a diagram illustrating examples of the drive signals V_{DR1}-V_{DR2} generated by the control circuit 226 during a cycle 600 of the operating period T_{OP}, for example, when the control circuit 226 is controlling three of the LED drive circuits 221-225 to control the light source 210. For example, the light source 210 may comprise two emitter circuits (e.g., the emitter circuits 211-212) and/or the control circuit 226 may determine to control two of the LED drive circuits (e.g., the LED drive circuits 221-222) based on the color-control mode in which the control circuit is presently operating and/or the emitter color of the emitters in each of the emitter circuits of the light source 210. The control circuit 226 may be configured to control the LED drive circuits 221-222 to generate with pulses 611-612 having respective on times T_{ON1}-T_{ON2} during respective time slots 601-602 of the cycle 600. The control circuit 226 may be configured to control the third, fourth, and fifth drive signals V_{DR3}-V_{DR5} to be driven low (e.g., towards approximately circuit common). Each of the time slots 601-602 may be characterized by a respective slot time T_{SLOT1}, T_{SLOT2}. The time slots 601-602 may extend across the length of the operating period T_{OP}, (e.g., such that the sum of the slot times T_{SLOT1}-T_{SLOT2} may be equal to the operating period T_{OP}).

As shown in FIG. 6, the control circuit 226 may be configured to generate the drive signals V_{DR1}-V_{DR2} such that the pulses 611-612 are non-overlapping (e.g., substantially non-overlapping). When the target intensity level L_{TRGT} of the cumulative light emitted by the light source 210 is at the high-end intensity level L_{HE}, the duty cycles d₁-d₂ of the drive signals V_{DR1}-V_{DR2} may be sized such that the duty cycles d₁-d₂ add up to approximately 100% (e.g., the sum of the on time T_{ON1}-T_{ON2} may be approximately equal to the operating period T_{OP}). When the target intensity level L_{TRGT} of the cumulative light emitted by the light source 210 is at the high-end intensity level L_{HE}, the on times T_{ON1}-T_{ON2} of the respective drive signals V_{DR1}-V_{DR2} may each be approximately equal to the slot times T_{SLOT1}-T_{SLOT2} of the respective time slots 601-602. While FIG. 6 is shown with the control circuit 226 generating the drive signals V_{DR1}-V_{DR2} to control the first and second LED drive circuits 221-222, the control circuit 226 could generate the appropriate drive signals to control any two of the LED drive circuits 221-225 (e.g., depending upon which of the emitter circuits 211-215 of the light source 210 the driver module 220 needs to control).

When the target intensity level L_{TRGT} of the cumulative light emitted by the light source 210 is less than the high-end intensity level L_{HE}, the control circuit 226 may be configured to generate the drive signals V_{DR1}-V_{DR2} such that at least one of the on times T_{ON1}-T_{ON2} is less than the slot time T_{SLOT1}-T_{SLOT2} of the respective time slot 601-602. The control circuit 226 may be configured to generate the drive signals V_{DR1}-V_{DR2} such that at least one of the time slots 601-602 may comprise a dead time T_{DT} during which the control circuit does not drive any of the drive signals V_{DR1}-V_{DR2} high towards the supply voltage V_{CC}. For example, the control circuit 226 may be configured to add the dead time T_{DT} to the one of the time slots 601-602 that has the shortest respective one of the on times T_{ON1}-T_{ON2} (e.g., in a similar manner as shown in FIG. 4B and described above).

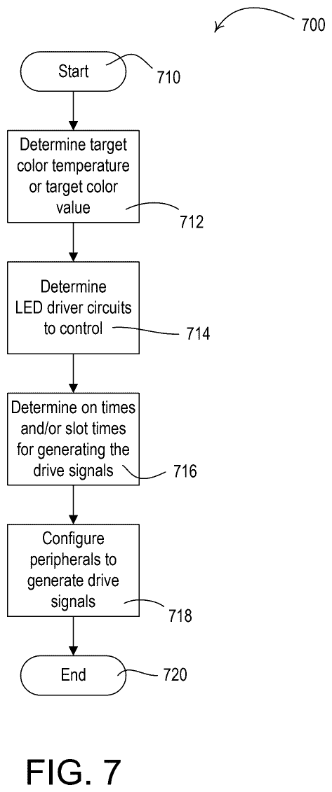

FIG. 7 is a flowchart of an example procedure 700 for controlling a light source at a load control device (e.g., one of the load control devices of FIG. 1, such as the dimmer switch 110, the LED driver 120, and/or the controllable light source 130, and/or the driver module 220 of FIG. 2). The control procedure 700 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. For example, the control circuit may execute the control procedure 700 at 710 periodically and/or in response to receiving the message comprising a color-temperature-adjustment command or a full-color-adjustment command.

At 712, the control circuit may determine a target color temperature T_{TRGT} (e.g., when operating in a color-temperature-control mode) or a target color value (e.g., when operating in a full-color-control mode). For example, the target color value may be defined by a target x-chromaticity coordinate X_{TRGT} and a target y-chromaticity coordinate Y_{TRGT}. The control circuit may determine the target color temperature T_{TRGT} in response to receiving a color-temperature-adjustment command or the target color value in response to receiving a full-color-adjustment command.

At 714, the control circuit may determine which of the LED drive circuits to control based on the color-control mode in which the control circuit is presently operating and/or a light source type for the light source, which may be stored in memory. The control circuit may be configured to determine which of the LED drive circuits to control based on the number of the number of emitter circuits in the light source. For example, the control circuit may be configured to determine the number of emitter circuits in the light source based on the light source type for the light source. In addition, the control circuit may be configured to determine which of the LED drive circuits to control based on the color-control mode in which the control circuit is presently operating and/or the emitter color of the emitters in each of the emitter circuits of the light source. For example, the control circuit may be configured to determine the emitter color of each of the emitter circuits of the light source based on a light source type for the light source.

At 716, the control circuit may determine respective on times T_{ON1}-T_{ON5} and/or respective slot times S_{LOT1}-S_{LOT5} for generating the drive signals V_{DR1}-V_{DR5}. The control circuit may be configured to determine duty cycles d₁-d₅ that may be used to calculate the respective on times T_{ON1}-T_{ON5} and/or respective slot times S_{LOT1}-S_{LOT5} used for generating the drive signals V_{DR1}-V_{DR5}. For example, the control circuit may be configured to determine the duty cycles d₁-d₅ for the respective drive signals V_{DR1}-V_{DR5} based on which of the five LED drive circuits that the control circuit has determined to control (e.g., based on the color-control mode in which the control circuit is presently operating and/or the light source type as described above). In addition, the control circuit may be configured to determine the duty cycles d₁-d₅ for the respective drive signals V_{DR1}-V_{DR5} based on either the target color temperature T_{TRGT} (e.g., when operating in the color-temperature-control mode) or the target x-chromaticity coordinate X_{TRGT} and the target y-chromaticity coordinate Y_{TRGT} (e.g., when operating in the full-color-control mode).

At 718, the control circuit may configure one or more peripherals of the control circuit to generate the drive signals based on the duty cycles d₁-d₅ (e.g., as determined at 716), before the procedure 700 ends at 720. For example, the control circuit may configure a timer peripheral for allowing the timer peripheral to generate the drive signals V_{DR1}-V_{DR5} (e.g., when the light source comprises two emitter circuits as shown in FIG. 3).

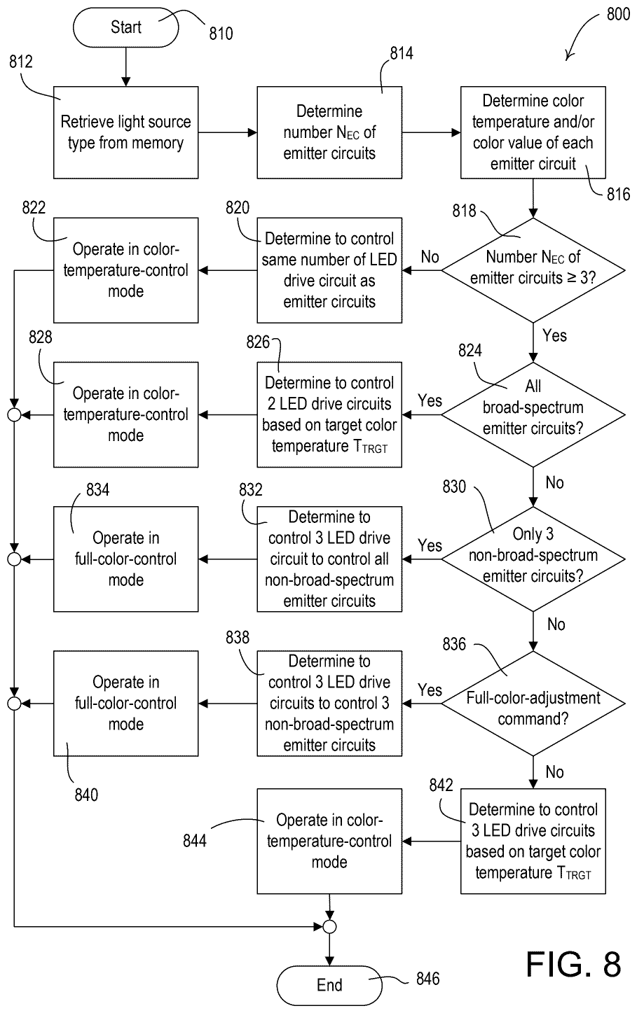

FIG. 8 is a flowchart of an example procedure 800 for controlling a light source at a load control device (e.g., one of the load control devices of FIG. 1, such as the dimmer switch 110, the LED driver 120, and/or the controllable light source 130, and/or the driver module 220 of FIG. 2). The control procedure 800 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. The control circuit may be configured to generate the drive signals V_{DR1}-V_{DR5} to control a color of the cumulative light emitted by the light source towards a target color temperature T_{TRGT} (e.g., when operating in a color-temperature-control mode) or a target color value (e.g., when operating in a full-color-control mode). The control circuit may be configured to execute the procedure 800 to determine which of the LED drive circuits to control to control the color of the cumulative light emitted by the light source towards the target color temperature T_{TRGT} or the target color value. For example, the control circuit may execute the procedure 800 at 810 periodically and/or in response to receiving the message comprising a color-temperature-adjustment command or a full-color-adjustment command. The control circuit may be configured to execute the procedure 800, for example, at 714 of the procedure 700 shown in FIG. 7.

At 812, the control circuit may retrieve a light source type from memory (e.g., the memory 228). The light source type may be stored in memory during, for example, a commissioning procedure of a load control system in which the load control device is included. For example, the light source type may indicate a number of emitter circuits included in the light source controlled by the load control device and/or an emitter color of the emitters in each of the emitter circuits of the light source. The emitter color may be a color temperature of the emitters in the respective emitter circuit (e.g., when the emitters are broad-spectrum LEDs) or a color value (e.g., as indicated by an x-chromaticity coordinate and a y-chromaticity coordinate) of the emitters in the respective emitter circuit (e.g., when the emitters are non-broad-spectrum LEDs).

Alternatively or additionally, and in some examples, the light source type may indicate a number emitter circuits in the plurality of emitter circuits and/or a type of the light-emitting diodes in each emitter circuit of the plurality of emitter circuits. For example, the light source type may indicate the number of broad spectrum light-emitting diodes in each emitter circuit of the plurality of emitter circuits and/or the number of non-broad spectrum light-emitting diodes in each emitter circuit of the plurality of emitter circuits. For instance, the light source type may indicate whether the light-emitting diodes in each emitter circuit of the plurality of emitter circuits are configured to emit light that is characterized by a color temperature on a black body curve and/or a color value for providing full color control. So, the light source type may indicate whether the light-emitting diodes in each emitter circuit of the plurality of emitter circuit are on the black body curve. Further, the light source type may indicate one or more characteristics of light that is configured to be emitted by the light-emitting diodes in each emitter circuit of the plurality of emitter circuits. Finally, in some examples, the light source type may indicate a form factor of the light source (e.g., indicate whether the light source is configured as tape lighting, track lighting, floor washer lighting, etc.).

At 814, the control circuit may determine a number N_{EC} of emitter circuits in the light source as indicated by the light source type (e.g., that is determined at 812). At 816, the control circuit may determine the emitter color (e.g., the color temperature and/or color value) of each of the emitter circuits in the light source as indicated by the light source type (e.g., that is determined at 812).

At 818, the control circuit may determine if the number N_{EC} of emitter circuits in the light source is greater than or equal to three. When the number N_{EC} of emitter circuits in the light source is less than three (e.g., the number N_{EC} of emitter circuits in the light source is less than or equal to two) at 818, the control circuit may determine to control the same number of the LED drive circuits as the number N_{EC} of emitter circuits in the light source (e.g., to thus control all of the emitter circuits) at 820 and operate in the color-temperature-control mode at 822, before the procedure ends at 846. For example, when the light source comprises two emitter circuit that may each include broad-spectrum LEDs configured to emit light (e.g., white light) at a color temperature (e.g., a different color temperature) that is along a black body curve, the control circuit may determine to control two of the LED drive circuits to control the two emitter circuits of the light source at 820 and operate in the color-temperature-control mode at 822 to subsequently be able to adjust the present color temperature of the cumulative light emitted by the light source towards the target color temperature T_{TRGT}.

When the number N_{EC} of emitter circuits in the light source is greater than or equal to three at 818, the control circuit may determine whether all of the emitter circuits of the light source are broad-spectrum emitter circuits (e.g., all of the emitter circuits include broad-spectrum LEDs) at 824. When all of the emitter circuits of the light source are broad-spectrum emitter circuits at 824, the control circuit may determine to control two of the LED drive circuits based on the target color temperature T_{TRGT} at 826 and operate in the color-temperature-control mode at 828, before the procedure 800 ends at 846. For example, the control circuit may determine that all of the emitter circuits of the light source are broad-spectrum emitter circuits at 824 when the light source comprises three emitter circuits that include broad-spectrum LEDs configured to emit light at respective first, second, and third color temperatures T₁, T₂, T₃, where the second color temperature T₂ is greater than the first color temperature T₁ and the third color temperature T₃ is greater than the second color temperature T₂. At 826, the control circuit may be configured to determine to control the two of the LED drive circuits to control the emitter circuits having the first and second color temperatures T₁, T₂ when the target color temperature T_{TRGT} is greater than or equal to the first color temperature T₁ and less than or equal to the second color temperature T₂. In addition, at 826, the control circuit may be configured to determine to control the two of the LED drive circuits to control the emitter circuits having the second and third color temperatures T₁, T₂ when the target color temperature T_{TRGT} is greater than the second color temperature T₂ and less than or equal to the third color temperature T₃. The control circuit may be configured to operate in the color-temperature-control mode at 828 to subsequently be able to adjust the present color temperature of the cumulative light emitted by the light source towards the target color temperature T_{TRGT}.

When all of the emitter circuits of the light source are not broad-spectrum emitter circuits at 824, the control circuit may determine if there are only three non-broad-spectrum emitter circuits (e.g., there are only three emitter circuits that each include non-broad-spectrum LEDs) in the light source at 830. When there are only three non-broad-spectrum emitter circuits at 830, the control circuit may determine to control three of the LED drive circuits to control the three non-broad-spectrum emitter circuits at 832, and operate in the full-color-control mode at 834, before the procedure 800 ends at 846. For example, the control circuit may determine that there are only three non-broad-spectrum emitter circuits at 830 when the light source comprises three emitter circuits that include non-broad-spectrum LEDs configured to emit light at a first color value (e.g., a red color value), a second color value (e.g., a blue color value), and a third color value (e.g., a green color value). The control circuit may be configured to operate in the full-color-control mode at 834 to subsequently be able to adjust the present color value of the cumulative light emitted by the light source towards the target color.

When there are not only three non-broad-spectrum emitter circuits in the light source at 830, the control circuit may determine if the last received color-adjustment command is a full-color-adjustment command at 836. For example, the control circuit may be configured to determine that there are not only three non-broad-spectrum emitter circuits in the light source at 830 when the light source comprises two emitter circuits including broad-spectrum LEDs configured to emit light at respective color temperatures T₁, T₂, and three emitter circuits including non-broad-spectrum LEDs configured to emit light at a first color value (e.g., a red color value), a second color value (e.g., a blue color value), and a third color value (e.g., a green color value). When the last received command is a full-color-adjustment command at 836, the control circuit may determine to control three of the LED drive circuits to control the three emitter circuits that include non-broad-spectrum LEDs at 838 and operate in the full-color-control mode at 840, before the procedure 800 ends at 846. The control circuit may be configured to operate in the full-color-control mode at 840 to subsequently be able to adjust the present color value of the cumulative light emitted by the light source towards the target color.

When the last received color adjustment command is a full-color-adjustment command (e.g., the last received color-adjustment command is a color-temperature-adjustment command) at 836, the control circuit may determine to control three of the LED drive circuits to control three of the emitter circuits of the light source based on the target color temperature T_{TRGT} at 842 and operate in the color-temperature-control mode at 844, before the procedure 800 ends at 846. For example, the control circuit may be configured to determine which three of the LED drive circuits such that the target color temperature T_{TRGT} is located within a gamut formed by the three emitter circuits controlled by those three LED drive circuits. When the target color temperature T_{TRGT} is greater than to equal to the first color temperature T₁ and less than the second color temperature T₂, the control circuit may determine to control the two LED drive circuits that control the two emitter circuits having the broad-spectrum LEDs and one of the LED drive circuits that control one of the emitter circuits having non-broad-spectrum LEDs (e.g., the non-broad-spectrum LEDs at the green color value). When the target color temperature T_{TRGT} is less than the first color temperature T₁, the control circuit may determine to control the LED drive circuit that control the emitter circuits having the broad-spectrum LEDs at the first color temperature T₁ and two of the LED drive circuits that control tow of the emitter circuits having non-broad-spectrum LEDs (e.g., the non-broad-spectrum LEDs at the red color value and the green color value). When the target color temperature T_{TRGT} is greater than the second color temperature T₂, the control circuit may determine to control the LED drive circuit that control the emitter circuits having the broad-spectrum LEDs at the second color temperature T₂ and two of the LED drive circuits that control two of the emitter circuits having non-broad-spectrum LEDs (e.g., the non-broad-spectrum LEDs at the blue color value and the green color value). The control circuit may be configured to operate in the color-temperature-control mode at 844 to subsequently be able to adjust the present color temperature of the cumulative light emitted by the light source towards the target color temperature T_{TRGT}.

What is claimed is:

1. A load control device for controlling a light source comprising a plurality of emitter circuits, the load control device comprising:
a plurality of drive circuits for controlling respective ones of the emitter circuits;
a memory configured to store data;
a communication circuit configured to receive messages;
a control circuit configured to control each of the drive circuits to control an individual intensity level of the respective emitter circuit;
wherein the control circuit is further configured to:
receive, via the communication circuit, a message including configuration data comprising a light source type;
store, in the memory, the configuration data comprising the light source type; and
control the drive circuits to adjust the individual intensity level of each of the emitter circuits to adjust a present color of the cumulative light emitted by the emitter circuits towards a target color based on the light source type in the configuration data stored in the memory.

2. The load control device of claim 1, wherein the control circuit is configured to:
adjust a present color temperature of the cumulative light emitted by the emitter circuits towards a target color temperature when operating in a color-temperature-control mode; and
adjust a present color value of the cumulative light emitted by the emitter circuits towards a target color value when operating in a full-color-control mode.

3. The load control device of claim 2, wherein, in response to the light source type in the configuration data stored in the memory, the control circuit is configured to determine which of the plurality of drive circuits to control.

4. The load control device of claim 3, wherein the control circuit is configured to:
determine a number of emitter circuits in the light source in response to the light source type in the configuration data stored in the memory; and
determine which of the plurality of drive circuits to control in response to the number of emitter circuits indicated by the light source type.

5. The load control device of claim 4, wherein the control circuit is configured to:
determine an emitter color of each of the emitter circuits in the light source in response to the light source type in the configuration data stored in the memory, wherein the emitter color indicates a respective color temperature of emitters of one of the emitter circuits when the emitter circuit includes broad-spectrum light-emitting diodes, and indicates a color value of emitters of one of the emitter circuits when the emitter circuit includes non-broad-spectrum light-emitting diodes; and
determine which of the plurality of drive circuits to control in response to the emitter color of each of the emitter circuits indicated by the light source type.

6. The load control device of claim 5, wherein, when the light source type indicates that the light source comprises two emitter circuits having broad-spectrum light-emitting diodes and three emitter circuits having non-broad-spectrum light-emitting diodes and a last-received color-adjustment commands was a color-temperature-adjustment command, the control circuit is configured to:
determine to operate in the color-temperature-control mode;
when the target color temperature is between a first color temperature and a second color temperature of respective ones of the two emitter circuits having broad-spectrum light-emitting diodes, determine to control two of the plurality of drive circuits for controlling the two emitter circuits having broad-spectrum light-emitting diodes and one of the plurality of drive circuits for controlling one of the emitter circuits having non-broad-spectrum light-emitting diodes.

7. The load control device of claim 6, wherein when the target color temperature is not between the first color temperature and the second color temperature, the control circuit is configured to determine to control one of the plurality of drive circuits for controlling the one of the emitter circuits having broad-spectrum light-emitting diodes and two of the plurality of drive circuits for controlling two of the emitter circuits having non-broad-spectrum light-emitting diodes.

8. The load control device of claim 6, wherein a color value of the one of the emitter circuits having non-broad-spectrum light-emitting diodes that is controlled by the one of the plurality of drive circuits is green.

9. The load control device of claim 5, wherein, when the light source type indicates that the light source comprises two emitter circuits having broad-spectrum light-emitting diodes and three emitter circuits having non-broad-spectrum light-emitting diodes and a last-received color-adjustment command was a full-color-adjustment command, the control circuit is configured to determine to operate in the full-color-control mode and to control three of the plurality of drive circuits for controlling the three emitter circuits having non-broad-spectrum light-emitting diodes.

10. The load control device of claim 5, wherein, when the light source type indicates that the light source comprises three emitter circuits and each of the emitter circuits comprise non-broad-spectrum light-emitting diodes, the control circuit is configured to determine to operate in the full-color-control mode and to control three of the plurality of drive circuits.

11. The load control device of claim 5, wherein, when the light source type indicates that the light source comprises three or more emitter circuits and each of the emitter circuits comprise broad-spectrum light-emitting diodes, the control circuit is configured to determine to operate in the color-temperature-control mode and to control two of the plurality of drive circuits based on the target color temperature and the emitter color of each of the emitter circuits indicated by the light source type.

12. The load control device of claim 4, wherein, when the light source type indicates that the light source comprises two emitter circuits, the control circuit is configured to operate in the color-temperature-control mode and to determine to control two of the plurality of drive circuits.

13. The load control device of claim 3, wherein, in response to the light source type in the configuration data stored in the memory, the control circuit is configured to determine duty cycles for generating drive signals for the controlling the drive circuits to control an individual intensity level of each of the respective emitter circuits.

14. The load control device of claim 1, wherein the control circuit is configured to determine a number of emitter circuits in the light source in response to the light source type in the configuration data stored in the memory.

15. The load control device of claim 14, wherein the control circuit is configured to determine an emitter color of each of the emitter circuits in the light source in response to the light source type in the configuration data stored in the memory, wherein the emitter color indicates a respective color temperature of emitters of one of the emitter circuits when the emitter circuit includes broad-spectrum light-emitting diodes, and indicates a color value of emitters of one of the emitter circuits when the emitter circuit includes non-broad-spectrum light-emitting diodes.

16. The load control device of claim 1, wherein the control circuit is configured to receive, via the communication circuit, the message comprising the configuration data comprising the light source type during a commissioning procedure of a load control system in which the load control device is located.

17. The load control device of claim 1, wherein the light source type indicates a number emitter circuits in the plurality of emitter circuits or a type of the light-emitting diodes in each emitter circuit of the plurality of emitter circuits.

18. The load control device of claim 1, wherein the light source type indicates a number of broad spectrum light-emitting diodes in each emitter circuit of the plurality of emitter circuits or a number of non-broad spectrum light-emitting diodes in each emitter circuit of the plurality of emitter circuits.

19. The load control device of claim 1, wherein the light source type indicates whether the light-emitting diodes in each emitter circuit of the plurality of emitter circuit are on a black body curve.

20. The load control device of claim 1, wherein the light source type indicates whether the light-emitting diodes in each emitter circuit of the plurality of emitter circuits are configured to emit light that is characterized by a color temperature on a black body curve or characterized by a color value for providing full color control.

21.-60. (canceled)
